(19) United States
(12) Patent Application Publication
(10) Pub. No.: US 2026/0286067 A1
(43) Pub. Date: Sep. 24, 2026

(54) OXYALKYLATED LIGNIN POLYOLS, RELATED COMPOSITIONS, AND RELATED METHODS

(71) Applicant: BOARD OF TRUSTEES OF MICHIGAN STATE UNIVERSITY, East Lansing, MI (US)

(72) Inventors: Mojgan Nejad, Okemos, MI (US); Enoch Kofi Acquah, East Lansing, MI (US); Manasseh Tetteh Agbedam, East Lansing, MI (US)

(21) Appl. No.: 19/473,526

(22) PCT Filed: Apr. 9, 2024
(86) PCT No.: PCT/US2024/023715

§ 371 Date: Oct. 8, 2025

Related U.S. Application Data
(60) Provisional application No. 63/458,251, filed on Apr. 10, 2023.
(60) Provisional application No. 63/569,914, filed on Mar. 26, 2024.

(51) Int. Cl. C08H 7/00; C08G 63/81; C08G 71/04

(52) U.S. Cl. CPC C08H 6/00; C08G 63/81; C08G 71/04

(57) ABSTRACT

The disclosure relates to methods for forming oxyalkylated lignin polyols as well as related polyols and polymers. A reaction mixture including one or more of a cyclic alkyl carbonate, a dialkyl carbonate, a lignin, a polyol reactive co-solvent, and an oxyalkylation catalyst is maintained at sufficient temperature and pressure conditions to form the oxyalkylated lignin polyol, for example via one or more oxyalkylation reactions and/or one or more transesterification reaction(s). The oxyalkylated lignin polyol can be subsequently reacted with a polyisocyanate or a polyacid compound to form a corresponding polyurethane or polyester polymer. The disclosure further relates to the oxyalkylated lignin polyols and corresponding polymers formed therefrom.

### CROSS REFERENCE TO RELATED APPLICATION

Priority is claimed to U.S. Provisional Application No. 63/458,251 filed on Apr. 10, 2023 and U.S. Provisional Application No. 63/569,914 filed on Mar. 26, 2024, each of which is incorporated herein by reference in its entirety.

### STATEMENT OF GOVERNMENT INTEREST

None.

### BACKGROUND OF THE DISCLOSURE

### Field of the Disclosure

The disclosure relates to methods for forming oxyalkylated lignin polyols as well as related polyols and polymers. A reaction mixture including one or more of a cyclic alkyl carbonate, a dialkyl carbonate, a lignin, a polyol reactive co-solvent, and an oxyalkylation catalyst is maintained at sufficient temperature and pressure conditions to form the oxyalkylated lignin polyol, for example via one or more oxyalkylation reactions and/or one or more transesterification reaction(s). The oxyalkylated lignin polyol can be subsequently reacted with a polyisocyanate or a polyacid compound to form a corresponding polyurethane or polyester polymer.

### Background

International Publication No. WO 2022/192615 is directed to methods for forming oxyalkylated lignin polyols. An initial reaction mixture including a cyclic alkyl carbonate and a wet lignin is heated in the absence of an oxyalkylation catalyst to remove at least a portion of the water from the reaction mixture. An oxyalkylation catalyst is added to the resulting dehydrated reaction mixture, which is then heated to perform an oxyalkylation reaction between the cyclic alkyl carbonate with the lignin, thereby forming an oxyalkylated lignin polyol reaction product.

### SUMMARY

In an aspect, the disclosure relates to a method for forming an oxyalkylated lignin polyol, the method comprising: providing a reaction mixture comprising: a cyclic alkyl carbonate, a lignin, a polyol reactive co-solvent, and an oxyalkylation catalyst; and performing an oxyalkylation reaction in the reaction mixture to react the cyclic alkyl carbonate with the lignin, thereby forming an oxyalkylated lignin polyol reaction product.

In a refinement, the oxyalkylation reaction further reacts the cyclic alkyl carbonate with the polyol, thereby forming a ring-opened adduct of the polyol and the cyclic alkyl carbonate (e.g., with the adduct being represented by [polyol]-[OC(═O)O]-[hydroxylated alkyl group from cyclic alkyl carbonate], such as [PEG]-[OC(═O)O]—[CH₂—CH(CH₃)OH with PEG and/or castor oil as the co-polyol/solvent and propylene carbonate as the cyclic alkyl carbonate]).

In a refinement, unreacted cyclic alkyl carbonate remaining in the reaction product is not more than 30 wt. % relative to total (or original) cyclic alkyl carbonate added to the reaction mixture (e.g., at least 0.1, 1, 2, 5, 10, or 15 wt. %. and/or up to 15, 20, 25, or 30 wt. % of cyclic alkyl carbonate is unreacted).

In a refinement, the cyclic alkyl carbonate is present in the reaction mixture in an amount of 10-50 wt. % (e.g., at least 10, 20, 25, or 30 wt. % and/or up to 20, 30, 35, 40, 45, or 50 wt. %); the lignin is present in the reaction mixture in an amount of 10-50 wt. % (e.g., at least 10, 20, 25, or 30 wt. % and/or up to 20, 30, 35, 40, 45, or 50 wt. %); and/or the polyol is present in the reaction mixture in an amount of 10-50 wt. % (e.g., at least 10, 20, 25, or 30 wt. % and/or up to 20, 30, 35, 40, 45, or 50 wt. %).

In a refinement, the polyol comprises a poly(alkylene oxide) diol (e.g., polyethylene glycol (PEG), polypropylene glycol (PPG), or other polyalkylene glycol with 2-10 or 4-8 carbon atoms in the alkylene group). The polyol more generally can include any hydrocarbon with two hydroxyl groups (diol), three hydroxyl groups (triol), or four or more hydroxyl groups.

In a refinement, the polyol has a molecular weight (e.g., molecular weight for a small molecule, or Mn or Mw for an oligomeric or polymeric polyol) in a range of 50-5000 g/mol (e.g., at least 50, 75, 100, 200, 300, 400, 500, or 700 g/mol and/or up to 100, 150, 200, 300, 400, 500, 700, 1000, 1500, 2000, 3000, or 5000 g/mol).

In a refinement, the method further comprises: performing a transesterification reaction with a dialkyl carbonate, thereby reacting (i) the dialkyl carbonate with (ii) one or both of the oxyalkylated lignin polyol and the ring-opened adduct of the polyol and the cyclic alkyl carbonate, thereby forming a plurality of carbonate adducts with the lignin and the polyol. In further refinements, the dialkyl carbonate can comprise at least one of dimethyl carbonate and diethyl carbonate. In further refinements, the dialkyl carbonate can be present in an amount in a range of 0.2 eq. to 2 eq. relative to total hydroxy content in the reaction mixture after the oxyalkylation reaction. In further refinements, the method can comprise removing at least a portion of the alcohol formed during the transesterification reaction from a reaction vessel for the transesterification reaction. In further refinements, the method can comprise performing the transesterification reaction (i) at a temperature in a range of 80-200° C., (ii) for time of 0.1-2 hr, and/or (iii) at a pressure in a range of 0.5 to 2 bar.

In an aspect, the disclosure relates to a method for forming an oxyalkylated lignin polyol, the method comprising: providing a reaction mixture comprising: a cyclic alkyl carbonate, a lignin, and an oxyalkylation catalyst; performing an oxyalkylation reaction in the reaction mixture to react the cyclic alkyl carbonate with the lignin, thereby forming an oxyalkylated lignin polyol reaction product; and performing a transesterification reaction at reduced pressure, thereby reacting (i) oxyalkylated lignin polyol with (ii) one or both of lignin and oxyalkylated lignin polyol, thereby forming a diol corresponding to the cyclic alkyl carbonate (e.g., propylene glycol formed when using propylene carbonate).

In a refinement, the method comprises performing the transesterification reaction at a pressure in a range of 0.001 bar to 0.5 bar.

In a refinement, the method comprises removing at least a portion of the diol formed during the transesterification reaction from a reaction vessel for the transesterification reaction (e.g., distilling or otherwise removing diol formed and vaporized during transesterification; removed diol can be used in a downstream process, for example as a co-reactant in a polyurethane or polyester formation process).

In a refinement, the method comprises comprising performing the transesterification reaction (i) at a temperature in a range of 100-200° C. and (ii) for time of 0.1-1 hr.

In an aspect, the disclosure relates to a method for forming an oxyalkylated lignin polyol, the method comprising: providing a reaction mixture comprising: a cyclic alkyl carbonate, a lignin, and an oxyalkylation catalyst; and performing an oxyalkylation reaction in the reaction mixture to react the cyclic alkyl carbonate with the lignin, thereby forming an oxyalkylated lignin polyol reaction product; wherein the lignin, prior to incorporation into the reaction mixture, has at least one of the following properties: a molecular weight in a range of 500 to 10000; a polydispersity in a range of 1.2 to 5 (e.g., 1.2 to 3); an aliphatic hydroxyl content in a range of 0.5 to 7 mmol/g; a phenol hydroxyl content in a range of 1 to 7 mmol/g (e.g., more generally at least 1, 2, 3, 4, 5, or 6 mmol/g and/or up to 4, 5, 6, 7, 8, or 9 mmol/g); a carboxylic hydroxyl content less than 1 mmol/g; and a total hydroxyl content in a range of 2 to 10 mmol/g.

In a refinement, the lignin is completely soluble in a reaction mixture containing (i) 10-50 wt. % cyclic alkyl carbonate, (ii) 10-50 wt. % lignin, and (iii) 10-50 wt. % polyol reactive co-solvent; and optionally the cyclic alkyl carbonate is present in the reaction mixture in an amount in a range of 1 eq to 5 eq relative to the lignin hydroxyl content.

In a refinement, the lignin comprises an acetone-soluble lignin fraction.

In an aspect, the disclosure relates to a method for forming an oxyalkylated lignin polyol, the method comprising: providing a reaction mixture comprising: a dialkyl carbonate, a polyol reactive co-solvent, and an oxyalkylation catalyst; performing a first transesterification reaction, thereby reacting (i) the dialkyl carbonate with (ii) the polyol, thereby forming a carbonate-terminated derivative of the polyol (e.g., with the derivative being represented by [R¹]—[OC(═O)O]—R—[OC(═O)O]—[R¹] and/or units thereof (e.g., three or more carbonate groups with intervening R groups), where R is an alkylene residue from the polyol and R¹ is an alkyl group from the dialkyl carbonate) and an alcohol corresponding to the dialkyl carbonate (e.g., methanol formed when using dimethyl carbonate, ethanol formed when using diethyl carbonate); and performing a second transesterification reaction with a lignin (e.g., added to reaction medium before, during, or after formation of the carbonate-terminated derivative of the polyol), thereby reacting (i) the carbonate-terminated derivative of the polyol with (ii) the lignin, thereby forming a polycarbonate oxyalkylated lignin polyol (e.g., represented by [HO-L]-[OC(═O)O]—{R—[OC(═O)O]-L}ₙ-[OH], where R is an alkylene residue from the polyol, L is a lignin residue, and n is 1, 2, 3, 4, 5, 6, 7, 8, 9, 10, up to 20, or combinations thereof in a distribution of reaction products with different numbers of carbonate groups).

In a refinement, the method comprises removing at least a portion of the alcohol formed during the first transesterification reaction from a reaction vessel for the first transesterification reaction.

In a refinement, the method comprises: performing the first transesterification reaction (i) at a temperature in a range of 80-200° C. and (ii) for time of 0.1-4 hr; and performing the second transesterification reaction (i) at a temperature in a range of 80-200° C., (ii) for time of 0.1-4 hr, and (iii) at a pressure in a range of 0.001 bar to 0.5 bar.

In a refinement, the dialkyl carbonate is present in the reaction mixture in an amount of 20-80 wt. %; and the polyol is present in the reaction mixture in an amount of 20-80 wt. % (e.g., with not more than 1, 2, 4, 8, or 10 wt. % components other than the dialkyl carbonate and the polyol in the (initial) reaction mixture).

In a refinement, in the second transesterification reaction: the lignin is present in an amount of 10-70 wt. % relative to a combined amount of the lignin and the carbonate-terminated derivative of the polyol; and the carbonate-terminated derivative of the polyol is present in an amount of 30-90 wt. % (e.g., with not more than 1, 2, 4, 8, or 10 wt. % components other than the lignin and the carbonate-terminated derivative of the polyol during the second transesterification reaction).

In a refinement, the polyol comprises a poly(alkylene oxide) diol; and the dialkyl carbonate comprises at least one of dimethyl carbonate and diethyl carbonate.

In a refinement, the dialkyl carbonate is present in an amount in a range of 1 eq. to 3 eq. relative to total hydroxy content (e.g., in mmol OH/g) in the reaction mixture before the first transesterification reaction (e.g., total hydroxy content of the initial polyol reactive co-solvent).

In an aspect, the disclosure relates to a method for forming an oxyalkylated lignin polyol, the method comprising: providing a reaction mixture comprising: a cyclic alkyl carbonate, a lignin, and an oxyalkylation catalyst; performing an oxyalkylation reaction in the reaction mixture to react the cyclic alkyl carbonate with the lignin, thereby forming an oxyalkylated lignin polyol reaction product with unreacted excess cyclic alkyl carbonate; performing a ring-opening reaction with water (e.g., added to reaction medium before, during, or after formation of the oxyalkylated lignin polyol reaction product), thereby reacting (i) the water with (ii) the unreacted excess cyclic alkyl carbonate, thereby forming a polycarbonate alkylene polyol (e.g., represented by [HO—R]—{[OC(═O)O]—R}ₙ—[OH], where R is an alkylene residue from the cyclic alkyl carbonate, and n is 1, 2, 3, 4, 5, 6, 7, 8, 9, 10, up to 20, or combinations thereof in a distribution of reaction products with different numbers of carbonate groups).

In a refinement, at least some unreacted excess cyclic alkyl carbonate remains after the ring-opening reaction.

In a refinement, the polyol comprises a poly(alkylene oxide) diol.

In a refinement, the method comprises: performing the oxyalkylation reaction (i) at a temperature in a range of 80-200° C. and (ii) for time of 0.1-4 hr; and performing the ring-opening reaction (i) at a temperature in a range of 80-200° C., and (ii) for time of 0.1-4 hr.

In a refinement, the cyclic alkyl carbonate is present in the reaction mixture in an amount of 50-90 wt. %; and the lignin is present in the reaction mixture in an amount of 10-50 wt. % (e.g., with not more than 1, 2, 4, 8, or 10 wt. % components other than the cyclic alkyl carbonate and the lignin in the (initial) reaction mixture).

In a refinement, the cyclic alkyl carbonate is present in an amount in a range of 1.5 eq. to 8 eq. relative to total hydroxy content (e.g., in mmol OH/g) in the reaction mixture before the oxyalkylation reaction (e.g., total hydroxy content of the initial lignin).

Various refinements of the disclosed methods and corresponding reactants, intermediates, and products are possible.

In a refinement, the cyclic alkyl carbonate has an alkyl group containing from 2 to 20 carbon atoms. For example, the cyclic alkyl carbonate can have at least 2, 3, 4, 5, or 6 and/or up to 3, 4, 5, 6, 8, 10, 12, 15, or 20 carbon atoms. The alkyl group can be linear or branched and/or substituted or unsubstituted. The alkyl group and the corresponding cyclic alkyl carbonate preferably does not include any free hydroxyl groups, free amine groups, and/or free carboxylic acid/carboxylate groups (e.g., when the alkyl group is a substituted group). The alkyl group does not include the carbon atom in the carbonyl group of the carbonate. Thus, the cyclic alkyl carbonate has 3 to 21 total carbon atoms in this embodiment. The alkyl group can be linked to the carbonate group oxygen atoms at adjacent carbon atoms (e.g., as in propylene carbonate with a 3-carbon alkyl group or ethylene carbonate with a 2-carbon alkyl group) or at non-adjacent carbon atoms (e.g., as in trimethylene carbonate with a 3-carbon alkyl group).

More generally, the cyclic alkyl carbonate is not particularly limited and can include any cyclic structure including a carbonate group (—OC(═O)O—) linked to an alkyl hydrocarbon group at both carbonate oxygen atoms, thus forming a cyclic structure from five or more atoms (e.g., one carbonyl carbon atom, two carbonate oxygen atoms, and at least two alkyl carbon atoms). The cyclic alkyl carbonate suitably is in liquid form both at lower ambient temperatures (e.g., room temperature or about 20-30° C.) and/or at higher temperatures that may be useful reaction temperatures for prepolymerization and/or curing. For example, propylene carbonate has a melting point of −49° C. and a boiling point of 242° C. Similarly, ethylene carbonate has a melting point of 35° C. and a boiling point of 243° C., so it would be useful, for example, in a high-temperature formulation (i.e., where it is in liquid form) or in liquid solution with another cyclic alkyl carbonate that is liquid at lower ambient temperatures, such as propylene carbonate. The cyclic alkyl carbonate further suitably serves as a solvent for the lignin, thus assisting water removal via solubilization of the lignin and release of the lignin's water into the liquid cyclic alkyl carbonate (e.g., as a dispersed aqueous phase) for subsequent removal via heating or distillation. Different lignins have varying solubilities in the cyclic alkyl carbonate medium. For example, organosolv lignins are soluble in propylene carbonate at room temperature, while other lignins such as kraft are soluble in propylene carbonate at higher temperatures of about 100-120° C. In either case, the lignin is solubilized at temperatures suitable for water removal via heating.

In a refinement, the cyclic alkyl carbonate has a structure according to Formula I, wherein: n is 1 to 10; i is each of 1 to n; and Rᵢ, R′ᵢ, Rₙ₊₁, and R′ₙ₊₁ are independently selected from the group consisting of H and linear or branched, substituted or unsubstituted C₁-C₁₀ alkyl groups. In the illustrated Formula I, the index n takes a single value from 1 to 10, such as 1, 2, or 3, for example at least 1, 2, or 3 and/or up to 2, 4, 6, 8, or 10. The index i takes all of the values from 1 to n for a given value of n (i.e., there are “i” groups for each of the n+1 total carbons in the ring). Rᵢ, R′ᵢ, Rₙ₊₁, and R′ₙ₊₁ can independently be H or linear or branched, substituted or unsubstituted C₁-C₁₀ alkyl groups, such as alkyl groups with 1, 2, or 3 carbons, for example at least 1, 2, or 3 and/or up to 2, 4, 6, 8, or 10 carbons. Substituents for substituted alkyl groups are generally not limited, but preferably do not include isocyanate-reactive groups such as hydroxyl groups, amine groups (e.g., primary, secondary), and carboxylic acid/carboxylate groups. For example, if n=2, then the structure of Formula I will have R₁, R′₁, R₂, R′₂, R₃, and R′₃ substituents, which can be independently selected to be hydrogen atoms or the alkyl groups noted above. Examples of suitable cyclic alkyl carbonates include propylene carbonate, ethylene carbonate, trimethylene carbonate, butylene carbonates (e.g., derived from one or more butanediols such as 1,2-, 1,3-, 1,4-, or 2,3-butanediol), pentylene carbonates (e.g., derived from one or more pentanediols), etc. In the context of the structure of Formula I for propylene carbonate, n is 1; R₁, R′₁, and R′₂ are H; and R₂ is CH₃. For ethylene carbonate, n is 1; and R₁, R′₁, R₂, and R′₂ are H. For trimethylene carbonate, n is 2; and R₁, R′₁, R₂, R′₂, R₃, and R′₃ are H.

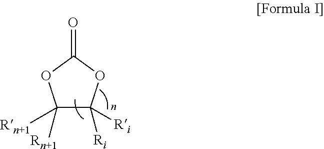

In a refinement, the (unmodified) lignin is derived from a biomass selected from the group consisting of hardwoods, softwoods, grasses, and combinations thereof.

In a refinement, the (unmodified) lignin is isolated from an extraction process selected from the group consisting of Kraft extraction, soda extraction, organosolv extraction, enzymatic hydrolysis extraction, ionic liquid, extraction, sulfite extraction, and combinations thereof.

The lignin is not particularly limited and generally can include lignin from any lignocellulosic biomass. Plants, in general, are comprised of cellulose, hemicellulose, lignin, extractives, and ash. Lignin typically constitutes 15-35 wt. % of woody plant cell walls, is an amorphous aromatic polymer made of phenylpropane units (e.g., coniferyl alcohol, sinapyl alcohol, p-coumaryl alcohol). The lignin for use according to the disclosure is not particularly limited to the source of lignin or its isolation method. Any type of lignin regardless of the biomass type (hardwood, softwood, grasses, and other agricultural residues) isolated through any extraction methods (such as Kraft, soda, organosolv, sulfite, enzymatic hydrolysis, and Ionic liquid) is suitable for use in the disclosed compositions and articles.

The lignin incorporated into the reaction mixture for oxyalkylation is generally an unmodified lignin. Unmodified lignin as used herein refers to lignin that has been separated from other components of its lignocellulosic biomass feedstock, such as the cellulose, hemicellulose, and other plant material components. Such separation processes (e.g., Kraft, soda, organosolv, sulfite, enzymatic hydrolysis, and ionic liquid) to isolate lignin from biomass may hydrolyze or otherwise fragment larger lignin molecules into smaller fragments, but this fragmentation and molecular weight reduction is still considered to provide an unmodified lignin as used herein in the corresponding compositions and methods. Such isolated lignins, which are also known as technical lignins, have not been subjected to further modifications or fragmentations, and are considered to provide an unmodified lignin as used herein in the corresponding compositions and methods. Modifications (or chemical modifications) that are generally avoided for the lignin used herein can include one or more of demethylation, phenolation, hydroxymethylation, etherification, depolymerization, and fractionation to monomer, dimers, trimers and oligomers.

The unmodified lignin is generally polymeric, as contrasted with various lignin monomers such as one or more of coniferyl alcohol, sinapyl alcohol, and p-coumaryl alcohol. For example, the unmodified lignin can have an average molecular weight (e.g., weight-average molecular weight, Mw) of at least 500 g/mol or at least 1000 g/mol. While technical lignins or other commercial lignins isolated from biomass could have some lignin monomers in the distribution of lignin components, the fraction of such lignin monomers in the unmodified lignin is suitably small, for example as reflected by the minimum average molecular weight of the unmodified lignin. In some embodiments, the unmodified lignin contains less than 10, 5, 2, 1, 0.5, 0.2, or 0.1 wt. % lignin monomers relative to the total unmodified lignin.

In a refinement, the (unmodified) lignin, prior to incorporation into the reaction mixture, has at least one of the following properties: a molecular weight in a range of 500 to 20000; a polydispersity in a range of 1.2 to 8; an aliphatic hydroxyl content in a range of 1 to 4 mmol/g; a phenol hydroxyl content in a range of 2 to 5 mmol/g; a carboxylic hydroxyl content less than 1 mmol/g; and a total hydroxyl content in a range of 3 to 9 mmol/g.

In a refinement, the (unmodified) lignin, prior to incorporation into the reaction mixture, has the following properties: a number-average molecular weight (Mn) in a range of 500 to 5000 (e.g., 500-2000, at least 500, 700, or 1000 and/or up to 1000, 2000, 3000, 4000, or 5000); a polydispersity in a range of 1.2 to 8 (or 1.2 to 3, or 2 to 4); a phenol hydroxyl content in a range of 1 to 7 mmol/g (or 2 to 5 mmol/g); a relative phenol hydroxyl content of at least 45% (or at least 55%) relative to hydroxyl groups of the unmodified lignin; and a carboxylic hydroxyl content less than 1 mmol/g (or less than 0.5 mmol/g).

More generally, the (unmodified) lignin, prior to reaction and/or incorporation into a reaction mixture for removal of water, suitably can be selected to have one or more properties related to molecular weight, molecular weight distribution, hydroxyl content, and hydroxyl content distribution. For example, a lower molecular weight and/or a lower polydispersity index can be desirable to promote access to and reactivity of the phenolic (or aromatic) hydroxy groups of the lignin, but lignin with any molecular weight and/or polydispersity can be used. Suitably, the weight-average molecular weight (M_{w}) can be in a range of 500 to 50000, 1000 to 3000, 3000 to 7000, 3000 to 10000, or 10000 to 50000. For example, M_{w} independently can be at least 500, 800, 1000, 1500, 2000, or 3000 and/or up to 1000, 1200, 1500, 2000, 3000, 5000, 7000, 10000, 15000, or 50000, but higher values are possible. Similar ranges can apply to the number-average molecular weight (Mₙ). Alternatively or additionally, the polydispersity index (M_{w}/Mₙ) can be in a range of 1.2 to 10, 1.2 to 8, 1.2 to 5, or 2 to 4, for example being at least 1.2, 1.4, 1.6, 1.8, or 2 and/or up to 1.5, 1.8, 2.0, 3.0, 4.0, 5.0, 6.0, 8.0, or 10, but higher values are possible. In a refinement, the aliphatic hydroxyl content of the unmodified lignin can be in a range of 0.5 to 7 mmol/g, 1 to 4 mmol/g, or 1 to 3 mmol/g, for example being at least 0.5, 1, 1.5 or 2 and/or up to 2, 2.5, 3, 3.5, 4, 5, 6, or 7 mmol/g. In a refinement, the phenol hydroxyl content of the unmodified lignin can be in a range of 1 to 7 mmol/g, 2 to 6 mmol/g, or 3 to 6 mmol/g, for example being at least 1, 1.5, 2, 2.5, 3, or 3.5 and/or up to 3, 3.5, 4, 4.5, 5, 5.5, 6, or 7 mmol/g. Alternatively or additionally, the phenol hydroxyl content can be at least 40, 50, 60, or 70% and/or up to 60, 65, 70, 75, or 80% of the total hydroxyl groups of the unmodified lignin (e.g., aliphatic, phenolic/aromatic, and carboxylic hydroxyl groups combined). Similarly, the phenol hydroxyl content individually can be greater than the aliphatic hydroxyl content individually and the carboxylic hydroxyl content individually. In a refinement, the carboxylic hydroxyl content of the unmodified lignin can be less than 1 mmol/g or 2 mmol/g, for example being at least 0.01, 0.1, or 0.2 and/or up to 0.2, 0.3, 0.4, 0.5, 0.7, 1, 1.5, or 2 mmol/g. In a refinement, the total hydroxyl content of the unmodified lignin can be in a range of 2 to 10 mmol/g, 3 to 9 mmol/g, or 4 to 7 mmol/g, for example being at least 2, 2.5, 3, 3.5, 4, 4.5, or 5 and/or up to 3.5, 4, 4.5, 5, 6, 7, 8, 9, or 10 mmol/g.

In a refinement, the cyclic alkyl carbonate is present in the reaction mixture in an amount in a range of 2 eq to 10 eq relative to the lignin hydroxyl content. For example, the cyclic alkyl carbonate can be present in the reaction mixture in an amount of at least 2, 2.5, 3, 3.5, 4, or 5 eq and/or up to 3, 4, 5, 6, 7, 8, or 10 eq relative to the lignin hydroxyl content. The molar equivalent “eq” unit represents in this case moles of cyclic alkyl carbonate molecules or moles of total hydroxyl (—OH) groups initially in the lignin, which represents the sum of phenolic/aromatic hydroxyl, aliphatic hydroxyl groups, and carboxylic acid hydroxyl groups initially in the lignin. Alternatively or additionally, the content of the reaction mixture can be expressed on a weight basis, for example containing 50-95 wt. % (e.g., at least 50, 60, or 70 wt. % and/or up to 70, 80, 90, or 95 wt. %) cyclic alkyl carbonate and 5-50 wt. % lignin (e.g., at least 5, 10, 15, 20, or 25 wt. % and/or up to 20, 30, 40, or 50 wt. %) (dry weight basis) based on the combined amount of cyclic alkyl carbonate and lignin (dry weight basis). There is generally no need to add solvents or other components to the reaction mixture, such that the (initial) reaction mixture is typically at least 95, 98, 99, or 99.5 wt. % of cyclic alkyl carbonate, lignin, and water combined, based on the combined weight of the reaction mixture.

In a refinement, the lignin initially in the reaction mixture comprises water in an amount in a range of 5 wt. % to 70 wt. % (10 wt. % to 50 wt. %) relative to the lignin (dry weight basis). More generally, the wet lignin initially in or added to the reaction mixture can have a water content of at least 1, 2, 5, 10, 15, 20, 25, 30, 40, or 50 wt. % and/or up to 20, 30, 40, 50, 60, 70, 80, or 100 wt. % relative to the lignin (dry weight basis). Alternatively the lignin initially in the reaction mixture can be a dried lignin, for example having a water content of at least 0.001, 0.01, or 0.1 wt. % and/or up to 0.1, 0.2, 0.3, 0.4, 0.5, 0.6, 0.8, or 1 wt. % relative to the lignin (dry weight basis).

In a refinement, the oxyalkylated lignin polyol reaction product is a liquid at ambient temperatures (e.g., room temperature or about 20-30° C.) and/or at higher temperatures that may be useful reaction temperatures for prepolymerization and/or curing. In a refinement, the oxyalkylated lignin polyol reaction product has a viscosity at 25° C. and shear rate of 50 s⁻¹ or 1000 s⁻¹ (1000 μm gap) in a range of 5 to 2000000 cP, for example at least 5, 10, 20, 50, 100, 200, 500, 1000, 2000, 5000, 10000, 12000, 15000, or 20000 cP and/or up to 1500, 3000, 5000, 10000, 20000, 30000, 50000, 100000, 200000, 30000, 40000, 500000, 10000000, or 2000000 cP. The viscosity range can apply to the oxyalkylated lignin polyol itself or the oxyalkylated lignin polyol in combination with other reaction products, such as the ring-opened adduct of the reactive polyol co-solvent and the cyclic alkyl carbonate.

In a refinement, the oxyalkylated lignin polyol reaction product has a hydroxy value in a range of 20 to 500 mg KOH/g or 20 to 800 mg KOH/g (e.g., at least 20, 30, 40, 60, 80, 100, 120, 150, 200, 250, 300, or 350 mg KOH/g and/or up to 50, 75, 100, 150, 200, 300, 400, 500, 600, 700, or 800 mg KOH/g). The hydroxy value can apply to the oxyalkylated lignin polyol itself or in combination with other reaction products, such as the ring-opened adduct of the reactive polyol co-solvent and the cyclic alkyl carbonate.

In a refinement, the oxyalkylation catalyst is present in the reaction mixture in an amount in a range of 0.04 eq to 0.06 eq relative to the lignin hydroxyl content (e.g., 0.03-0.08, 0.04-0.06, or about 0.05 eq; particularly useful for forming a rigid PU foam in a subsequent step).

In a refinement, the oxyalkylation catalyst is present in the reaction mixture in an amount in a range of 0.025 eq to 0.05 eq relative to the lignin phenolic hydroxyl content (e.g., 0.01-0.08, 0.02-0.06, 0.03-0.06, or 0.025-0.05 eq; particularly useful for forming a PU adhesive, flexible foam, or rigid foam in a subsequent step).

In a refinement, the cyclic alkyl carbonate is present in the reaction mixture in an amount in a range of 1 eq to 10 eq relative to the lignin hydroxyl content (e.g., at least 1, 1.2, 1.5, 1.7, 2, 2.5, 3, 3.5, 4, or 5 eq and/or up to 2, 2.5, 3, 4, 5, 6, 7, 8, or 10 eq relative to the lignin hydroxyl content). In a further refinement, the oxyalkylated lignin polyol reaction product has a viscosity at 25° C. and shear rate of 50 s⁻¹ or 1000 s⁻¹ (1000 μm gap) in a range of 5 to 10,000 cP, for example at least 5, 10, 20, 50, 100, 200, 500, 1000, 2000, 3000, or 5000 cP and/or up to 500, 1000, 1500, 3000, 5000, 10000 cP. In a further refinement, the oxyalkylated lignin polyol reaction product has a hydroxy value in a range of 80 to 500 mg KOH/g (e.g., at least 80, 100, 120, 150, 200, 250, 300, or 350 mg KOH/g and/or up to 50, 75, 100, 150, 200, 300, 400, 500 mg KOH/g).

In a refinement, the method comprises adding the oxyalkylation catalyst to the reaction mixture in an amount in a range of 0.01 eq to 0.2 eq relative to the lignin hydroxyl content. For example, the oxyalkylation catalyst can be present in the reaction mixture in an amount of at least 0.01, 0.02, 0.03, 0.04, or 0.05 eq and/or up to 0.06, 0.08, 0.1, 0.15, or 0.2 eq relative to the lignin hydroxyl content. The molar equivalent “eq” unit represents in this case moles of oxyalkylation catalyst molecules or moles of total hydroxyl (—OH) groups initially in the lignin, which represents the sum of phenolic/aromatic hydroxyl, aliphatic hydroxyl groups, and carboxylic acid hydroxyl groups initially in the lignin.

The oxyalkylation catalysts useful according to the disclosure are not particularly limited and can generally include base catalysts (e.g., strong bases or super bases), for example those known for use in transesterification reactions. Examples include 1,8-diazabicyclo[5.4.0]undec-7-ene (DBU), 1,5,7-Triazabicyclo[4.4.0]dec-5-ene, 1,4-diazabicyclo[2.2.2]octane (DABCO), potassium tert-butoxide, tetra-n-butylammonium bromide (TBAB) (phase transfer catalyst), potassium carbonate, pyridine, and triethylene amine.

In a refinement, the oxyalkylated lignin polyol reaction product has an aliphatic hydroxy content in a range of 0.2 mmol/g to 6 mmol/g. For example, the oxyalkylated lignin polyol can have an aliphatic hydroxy content of at least 0.2, 0.3, 0.5, 0.6, 0.8, 1, 1.2, 1.5, 1.7, 2, 2.5, 3, 3.5, or 4 mmol/g and/or up to 0.7, 1, 1.2, 1.5, 1.8, 2, 2.5, 3, 3.5, 4, 4.5, 5, 5.5, or 6 mmol/g.

The disclosed method can provide an oxyalkylated lignin polyol reaction product having an aliphatic hydroxy content that can be selected within a relatively wide range depending on a desired end use for the oxyalkylated lignin polyol. For example, oxyalkylated lignin polyols having relatively high aliphatic hydroxy contents (e.g., about 3 to 6 mmol/g) are particularly suitable for forming rigid polyurethane foams, because the high aliphatic hydroxy content provides many isocyanate-reactive sites that can in turn provide a high crosslinking density in a corresponding polyurethane polymer. Similarly, oxyalkylated lignin polyols having relatively low aliphatic hydroxy contents (e.g., about 0.5 to 2 mmol/g) are particularly suitable for forming flexible polyurethane foams or elastomers, because the low aliphatic hydroxy content provides sufficient isocyanate-reactive sites for polymerization, but not so many that would result in a highly crosslinked polyurethane polymer.

The oxyalkylation reaction can convert essentially all aromatic hydroxy and carboxylic acid groups in the original lignin to aliphatic hydroxy groups. For example, the oxyalkylated lignin polyol reaction product can be free or substantially free of aromatic hydroxy groups and/or carboxylic acid groups, such as having 0.001, 0.01, or 0.1 mmol/g or less aromatic hydroxy groups and/or carboxylic acid groups. Typically at least some of the original aliphatic hydroxy groups in the lignin also react via the oxyalkylation reaction such that the aliphatic hydroxy content in the oxyalkylated lignin polyol reaction product includes at least the oxyalkylated aliphatic hydroxy groups, but possibly also some remaining unreacted original aliphatic hydroxy groups in the lignin. The total number of hydroxy groups (e.g., aromatic, carboxylic, and aliphatic hydroxy groups combined) in a given molecule is generally conserved during the oxyalkylation reaction, but the overall molecular weight is generally increased with the addition of oxyalkyl groups, thus resulting in a lower total hydroxy group content on a per mass basis between the original lignin and the final oxyalkylated lignin polyol.

In a refinement, the method comprises performing the oxyalkylation reaction at a temperature in a range of 100° C. to 200° C. The oxyalkylation reaction more generally is performed at an elevated temperature (e.g., above 100° C.) to improve the rate and yield of the transesterification reaction, thereby improving the conversion of aromatic hydroxyl groups and to aliphatic hydroxyl groups in the oxyalkylated lignin polyol reaction product. Suitable reaction temperatures for the oxyalkylation reaction can be in the range of at least 80, 100, 110, 120, 130, or 140° C. and/or up to 120, 140, 150, 160, 170, 180, or 200° C. Suitable reaction times (or residence times in a continuous system) can be in the range of 0.25-24 hr, 0.5-12 hr, or 1-6 hr, for example about 3 hr (e.g., for reaction times of at least 0.1, 0.2, 0.3, or 0.5 hr and/or up to 1, 1.5, 2, 2.5, 3, 4, 5, 6, or 8 hr).

In a refinement, the method comprises performing the oxyalkylation reaction in a sealed reaction vessel. The oxyalkylation reaction is suitably performed in a closed or sealed reaction or pressure vessel, typically at a pressure above ambient or environmental pressure to prevent any inflow of air from the external environment. Performing the reaction in a sealed reaction vessel limits or prevents the loss of cyclic alkyl carbonate reactant during the reaction, thus improving conversion and yield for a given amount of added cyclic alkyl carbonate. Although the reaction temperature is generally below the boiling point of the cyclic alkyl carbonate (e.g., about 242° C. for propylene carbonate), the reaction temperature and corresponding vapor pressure of the cyclic alkyl carbonate is high enough to result in some vaporization and loss of the reactant in a reaction vessel open to the environment. Suitable reaction pressures can be in a range of 0.03-1 bar (about 0.5-15 psi), for example at least 0.03, 0.06, 0.1, 0.2, or 0.3 bar and/or up to 0.3, 0.5, 0.7, or 1 bar above ambient or environmental pressure (or a gauge pressure). The internal gaseous headspace in the reactor above the liquid reaction medium is suitably any inert or non-oxygen-containing gas such as nitrogen gas.

In a further refinement, the method further comprises venting carbon dioxide produced during the oxyalkylation reaction from the sealed reaction vessel. Carbon dioxide is a byproduct of the oxyalkylation reaction as shown in Schemes 1 and 2. Accumulation of carbon dioxide in the reaction system is undesirable, because it can create excessive pressures in the reaction vessel as well as increased concentrations of carbon dioxide in the liquid reaction medium. Carbon dioxide in the liquid reaction medium can neutralize and deactivate base catalyst compounds such as DBU serving as the oxyalkylation catalyst, thus limiting overall conversion. Thus in some embodiments, it can be desirable to periodically vent accumulated carbon dioxide in the reaction vessel headspace to reduce the overall carbon dioxide in the reaction system. After venting, the reaction system is returned to a closed or sealed state while the reaction continues, thus limiting possible loss of the cyclic alkyl carbonate during the reaction.

In a refinement, the method further comprises adding additional cyclic alkyl carbonate and additional oxyalkylation catalyst to the reaction mixture while performing the oxyalkylation reaction. As described above, the oxyalkylation catalyst can become ineffective during the course of an oxyalkylation reaction due to accumulation of carbon dioxide and catalyst deactivation, even with venting to remove carbon dioxide. In such cases, additional amounts of cyclic alkyl carbonate and fresh oxyalkylation catalyst can be added to the reaction vessel after starting the reaction with the initial cyclic alkyl carbonate and oxyalkylation catalyst. For example, evolution of carbon dioxide during the reaction can be monitored as an indicator of rate of reaction; when the rate of reaction drops significantly or stops, the additional cyclic alkyl carbonate and fresh oxyalkylation catalyst can be added to resume the reaction. Addition of the cyclic alkyl carbonate in separate aliquots in this manner also maintains a relatively lower excess of the carbonate, which in turn promotes reaction with the lignin instead of carbonate-carbonate self-polymerization.

In a refinement, the method further comprises adding an oil to the oxyalkylated lignin polyol reaction product, thereby (i) extracting at least a portion of unreacted cyclic alkyl carbonate from the reaction product into a separate oil phase comprising the oil and (ii) forming a concentrated oxyalkylated lignin polyol containing a reduced amount of cyclic alkyl carbonate relative to the oxyalkylated lignin polyol reaction product. The separation/extraction can reduce cyclic alkyl carbonate by about 10-40, 15-35, or 20-25 wt. % relative to the original reaction product. Such separation/extraction can also increase viscosity (e.g., measured at 25° C.) by a factor of 1.2-6, 1.5-5, or 2-4 relative to original reaction product. The oil can be liquid fatty acid triglyceride (e.g., liquid at ambient temperatures such as about 20-30° C.) such as castor oil or other vegetable oil. The oil is not particularly limited and can be any vegetable oil with favorable solubility properties (e.g., good solubility with lignin and/or cyclic alkyl carbonate), for example including oils with pendant hydroxyl groups on saturated or unsaturated alkyl chains, such as those in ricinoleic acid residues in castor oil or otherwise.

In a refinement, the method further comprises adding an isocyanate (e.g., diisocyanate) to the oxyalkylated lignin polyol reaction product and reacting the isocyanate and the oxyalkylated lignin polyol reaction product to form a polyurethane polymer. An advantage of the disclosed process is that oxyalkylated lignin polyol as originally formed is suitable for further reaction to form a corresponding polyurethane directly in the same reaction vessel used for both water removal and oxyalkylation (e.g., as a one-pot synthesis starting from wet lignin). The polyurethane can be a highly crosslinked thermoset, a lightly or non-crosslinked polymer, elastomer, etc. depending on the hydroxy content of the oxyalkylated lignin polyol and the functionality of the isocyanate. Typically, the base catalysts that are suitable as oxyalkylation catalysts also catalyze the reaction between the oxyalkylated lignin polyol and the isocyanates, so any residual catalyst remaining after oxyalkylation is generally sufficient for polyurethane formation. In some cases, due to the generally higher rate of reaction for the polyurethane formation, it can be desirable to neutralize some of the residual catalyst remaining after oxyalkylation (i.e., lowering the amount of active catalyst but retaining at least some active catalyst).

The isocyanate is not particularly limited and generally can include any aromatic, alicyclic, and/or aliphatic monomeric, oligomeric, and/or polymeric isocyanates having at least two reactive isocyanate groups (—NCO) (e.g., di- or higher poly-functional isocyanates). Suitable isocyanates contain on average 2-4 isocyanate groups. In some embodiments, the isocyanate includes a diisocyanate. In some embodiments, the isocyanate includes triisocyanate. Suitable diisocyanates can have the general structure (O═C═N)—R—(N═C═O), where R can include aromatic, alicyclic, and/or aliphatic groups, for example having at least 2, 4, 6, 8, 10 or 12 and/or up to 8, 12, 16, or 20 carbon atoms. Examples of specific isocyanates include 1,5-naphthylene diisocyanate, 4,4′-diphenylmethane diisocyanate (MDI), hydrogenated MDI, polymeric methylene diphenyl diisocyanate (pMDI), xylene diisocyanate (XDI), tetramethylxylol diisocyanate (TMXDI), 4,4′-diphenyl-dimethylmethane diisocyanate, di- and tetraalkyl-diphenylmethane diisocyanate, 4,4′-dibenzyl diiso-cyanate, 1,3-phenylene diisocyanate, 1,4-phenylene diisocyanate, one or more isomers of tolylene diisocyanate (TDI, such as toluene 2,4-diisocyanate), 1-methyl-2,4-diiso-cyanatocyclohexane, 1,6-diisocyanato-2,2,4-trimethyl-hexane, 1,6-diisocyanato-2,4,4-trimethylhexane, 1-iso-cyanatomethyl-3-isocyanato-1,5,5-trimethylcyclohexane, chlorinated and brominated diisocyanates, phosphorus-containing diisocyanates, 4,4′-diisocyanatophenyl-perfluoroethane, tetramethoxybutane 1,4-diisocyanate, butane 1,4-diisocyanate, hexane 1,6-diisocyanate (or hexamethylene diisocyanate; HDI), HDI dimer (HDID), HDI trimer (HDIT), HDI biuret, dicyclohexylmethane diisocyanate, cyclohexane 1,4-diisocyanate, ethylene diisocyanate, phthalic acid bisisocyanatoethyl ester, 1-chloromethylphenyl 2,4-diisocyanate, 1-bromomethylphenyl 2,6-diisocyanate, 3,3-bischloromethyl ether 4,4′-diphenyldiisocyanate, trimethylhexamethylene diisocyanate, 1,4-diisocyanato-butane, 1,2-diisocyanatododecane, and combinations thereof. The isocyanate can be biobased or made of synthetic feedstock. Examples of suitable biobased isocyanates include pentamethylene diisocyanate trimer, and isocyanates formed from base compounds to which isocyanate groups are attached (e.g., via suitable derivatization techniques), including isocyanate-terminated poly(lactic acid) having two or more isocyanate groups, isocyanate-terminated poly(hydroxyalkanaotes) having two or more isocyanate groups, isocyanate-terminated biobased polyesters having two or more isocyanate groups.

In a refinement, the method further comprises adding an organic acid (e.g., diacid) to the oxyalkylated lignin polyol reaction product and reacting the organic acid and the oxyalkylated lignin polyol reaction product to form a polyester polymer. This is analogous to the polyurethane formation as described above, but using an organic di- or higher-functional acid to form a corresponding polyester. Examples of suitable organic acids include alkyl and/or aryl acids such as terephthalic acid, maleic acid, and fumaric acid.

In another aspect, the disclosure relates to an oxyalkylated lignin polyol reaction product formed according to the disclosed method in any of its variously disclosed embodiments, refinements, etc. For example, in some aspects, the disclosure relates to an oxyalkylated lignin polyol comprising a reaction product between a cyclic alkyl carbonate and a lignin, the reaction product having one or more properties such as an aliphatic hydroxy content in a range of 0.2 mmol/g to 6 mmol/g, 0.1 mmol/g or less aromatic hydroxy groups, and/or 0.1 mmol/g or less carboxylic acid groups (or any disclosed sub-range(s) thereof).

In another aspect, the disclosure relates to a polyurethane polymer comprising: a (crosslinked) reaction product between an oxyalkylated lignin polyol (e.g., in any of its variously disclosed embodiments, refinements, etc.) and an isocyanate, for example as a product formed according to any of the variously disclosed methods.

In another aspect, the disclosure relates to a polyester polymer comprising: a (crosslinked) reaction product between the oxyalkylated lignin polyol (e.g., in any of its variously disclosed embodiments, refinements, etc.) and an organic acid, for example as a product formed according to any of the variously disclosed methods.

While the disclosed methods, compositions, and articles are susceptible of embodiments in various forms, specific embodiments of the disclosure are illustrated (and will hereafter be described) with the understanding that the disclosure is intended to be illustrative, and is not intended to limit the claims to the specific embodiments described and illustrated herein.

### DETAILED DESCRIPTION

Lignin has emerged as a promising sustainable alternative to partially replace petroleum-based polyols in polyurethane (PU) resins, owing to the presence of hydroxyl groups in its structure. However, lignin use in PU and other polymer-based applications faces, challenges such as low reactivity towards isocyanate due to sterically hindered phenolic hydroxyl groups and poor miscibility in conventional polyols. To resolve these challenges and expand applications of lignin in higher-value PU products, such as PU used in mass timber (structural), construction, and automotive applications, the disclosure provides improved reaction schemes to provide oxyalkylated lignin polyols (also referenced herein as “lignin polyols”) with tunable properties for PU and other polymer applications, for example in the formation of foams, such as flexible foams and rigid foams, elastomers, coatings, and adhesives. For example, the reaction product including the oxyalkylated lignin polyol (e.g., along with other components such as remaining reactants, additional products, etc.) can have one or both of a selected hydroxy value (e.g., mg KOH/g), and/or viscosity (e.g., cP measured at 25° C.) depending on the eventual end use of the lignin polyol. Suitable hydroxy values for rigid foam, coating, and adhesive applications can be about 200 to 300 mg KOH/g or about 180 to 500 or 180 to 800 mg KOH/g. Suitable hydroxy values for flexible foam and elastomer applications can be less than about 150 mg KOH/g or about 20 to 180 mg KOH/g. Suitable viscosity values for most applications are about 10,000 cP or less (e.g., measured at 25° C.).

In one aspect, an improved reaction scheme synthesizes liquid lignin polyols using a cyclic alkyl carbonate (e.g., propylene carbonate) and polyol reactive co-solvent (e.g., polyethylene glycol (PEG)). The cyclic alkyl carbonate converts (fully or partially) phenolic and carboxylic hydroxyl groups in lignin to aliphatic hydroxyl groups to increase lignin reactivity towards isocyanate. In addition, the polyol reactive co-solvent with varying molecular weights (e.g., monomeric or oligomeric polyol) is employed to produce a liquid lignin polyols solution with a lower amount of unreacted cyclic alkyl carbonate (i.e., which could undesirably act as a plasticizer in an eventual PU or other polymer formed from the lignin polyol), a tunable hydroxyl value, and a workable viscosity value. Other process modifications, such as specific selection of the oxyalkylation catalyst (e.g., 1,5,7-triazabicyclo [4.4.0]dec-5-ene catalyst (TBD)), a lower reaction pressure to remove diol byproducts such as propylene glycol formed during the reaction, and/or use of an acetone-(or other organic solvent-) soluble fraction of commercial lignins are also effective ways to attain lignin-polyol solution with lower viscosity and higher solubility (or better compatibility) with co-polyols. The formulated lignin polyol can be used directly without additional precipitation and drying steps in polyurethane resin formulations. In addition, the oxyalkylated lignin polyol after reaction with the cyclic alkyl carbonate can be mixed with an oil (e.g., castor oil) as a co-biobased polyol. Most solid lignin and oxyalkylated lignins are soluble in castor oil. After suitable separation time (e.g., a few days), the mixture forms two phases, separating about 20% of unreacted cyclic alkyl carbonate from the lignin polyol solution in oil. This method can easily remove some of the unreacted cyclic alkyl carbonate from the liquid lignin polyol solution by keeping the lignin polyol in the solution using another biobased polyol. These liquid lignin polyols with polyol reactive co-solvents and/or oils (with higher biobased carbon content) can be used to replace petroleum-based polyols in the formulation of polyurethane coatings, foams, adhesive, and elastomers.

The disclosure relates to methods for forming oxyalkylated lignin polyols as well as related polyols and polymers. In the various methods, a reaction mixture including one or more of a cyclic alkyl carbonate, a dialkyl carbonate, a lignin, a polyol reactive co-solvent, and an oxyalkylation catalyst is maintained at sufficient temperature and pressure conditions (e.g., elevated temperature from heating; ambient or reduced pressure) to form the oxyalkylated lignin polyol. The oxyalkylated lignin polyol can be formed from one or more oxyalkylation reaction(s), such as between the cyclic alkyl carbonate with one or both of the lignin and the polyol reactive co-solvent, and one or more transesterification reaction(s), such as between one or more of the lignin, the polyol reactive co-solvent, the dialkyl carbonate, the cyclic alkyl carbonate, the oxyalkylated lignin polyol, and intermediates or derivatives thereof. In some embodiments, all of the reactants and catalyst are added to the (initial) reaction mixture prior to initiating the oxyalkylation and/or transesterification reaction(s). In some embodiments, a subset of the reactants and catalyst are added to the initial reaction mixture, and then further reactant(s) are added to an intermediate reaction mixture after at least some reaction has taken place. The oxyalkylated lignin polyol can be subsequently reacted with a polyisocyanate or a polyacid compound to form a corresponding polyurethane or polyester polymer, respectively. The disclosure further relates to the oxyalkylated lignin polyols and corresponding polymers formed therefrom.

The oxyalkylation reaction(s) can be performed using an oxyalkylation catalyst as generally known in the art (e.g., a base catalyst). In some embodiments, the catalyst can further catalyze the transesterification reaction(s). In a typical oxyalkylation reaction, the catalyst is added to the reaction mixture with the other reactants, and the reaction mixture is heated for a sufficient time and at a temperature to react the cyclic alkyl carbonate with the lignin to form the oxyalkylated lignin polyol. In particular, the hydroxyl groups of lignin are reactive towards and can participate in a ring-opening transesterification reaction with the cyclic alkyl carbonate in the presence of a catalyst. This reaction forms an ester linking group between the hydroxyl groups of lignin and the ring-opened cyclic alkyl carbonate. This process is illustrated in Scheme 1 below for a generic lignin residue having an aromatic hydroxyl group reacting with propylene carbonate as a representative cyclic alkyl carbonate. Ring-opening transesterification with aliphatic hydroxyl groups and the cyclic alkyl carbonate can likewise occur, for example by reacting with native aliphatic hydroxyl groups in the lignin and/or by reacting with aliphatic hydroxyl groups appended to the lignin by an earlier transesterification step. This process is illustrated in Scheme 2 below as an extension of Scheme 1 in which oxyalkyl side chains with n+1 oxyalkyl groups/residues are appended to a lignin substrate, for example where the degree of oxyalkylation can be controlled or selected based on the relative amount of cyclic alkyl carbonate added, reaction time, reaction temperature, etc.

As illustrated in Schemes 1 and 2, the transesterification product includes a pendant aliphatic hydroxy group still linked to the carbonate. This oxyalkyl aliphatic hydroxy group, similar to the lignin aliphatic hydroxy groups, is relatively more reactive with isocyanate groups than aromatic hydroxyl groups of lignin. Accordingly, the generated pendant aliphatic hydroxy groups in the oxyalkylated lignin polyol reaction product are particularly suitable for the formation of a lignin-based polyurethane by reaction with a di- or higher functionality polyisocyanate.

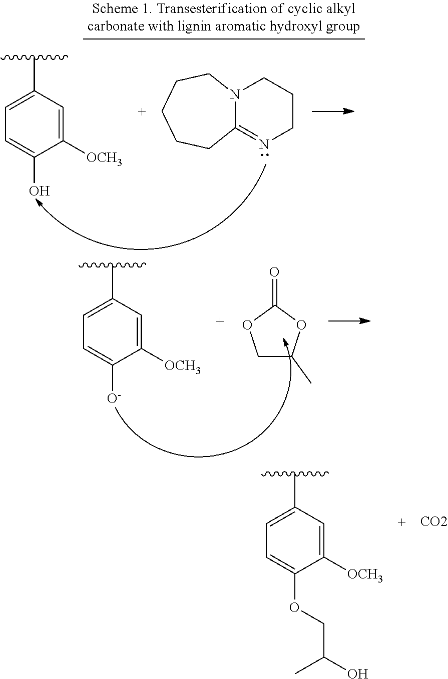

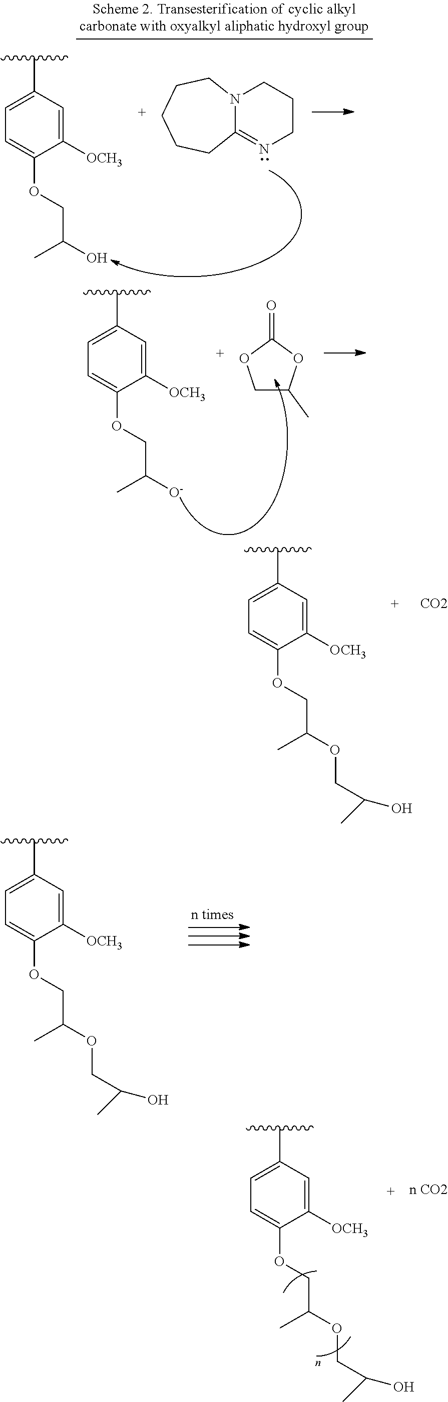

Oxyalkylation with a Polyol Reactive Co-Solvent

In an aspect, the oxyalkylated lignin polyol can be formed from a reaction mixture (e.g., initial reaction mixture) including a cyclic alkyl carbonate, a lignin, a polyol reactive co-solvent, and an oxyalkylation catalyst. The corresponding oxyalkylation reaction (e.g., upon sufficient heating) reacts the cyclic alkyl carbonate with the lignin to form an oxyalkylated lignin polyol reaction product. The oxyalkylation reaction can further react the cyclic alkyl carbonate with the polyol to form a ring-opened adduct of the polyol and the cyclic alkyl carbonate. The adduct can be represented by [polyol]-[OC(═O)O]-[hydroxylated alkyl group from cyclic alkyl carbonate], such as [PEG]-[OC(═O)O]—[CH₂—CH(CH₃)OH with PEG and/or castor oil as the co-polyol/solvent and propylene carbonate as the cyclic alkyl carbonate.

Representative reaction reactant, products, and steps are illustrated in Schemes 3-5. In the oxyalkylation reaction, lignin hydroxyl groups (e.g., phenolic, aliphatic, and carboxylic OH) undergo a ring-opening reaction with a cyclic alkyl carbonate such as propylene carbonate (PC) as illustrated in Scheme 3. Phenolic and carboxylic hydroxyl groups are deprotonated by the base catalyst leading to a nucleophilic attack on alkyl carbons in the cyclic alkyl carbonate that introduces ether linkages. This results in carbon dioxide production, which is typically vented from the reactor to avoid pressure increase. Aliphatic hydroxyl groups (e.g., in the lignin and/or the polyol reactive co-solvent), after deprotonation by basic catalyst, undergo nucleophilic attack on carbonyl carbons in the cyclic alkyl carbonate to produce a carbonate-linked OH-terminated chain, as illustrated in Scheme 4 with polyethylene glycol (PEG) as a representative polyol reactive co-solvent. Once aliphatic hydroxyl groups react with the cyclic alkyl carbonate to introduce carbonate linkages in the lignin chain, a transesterification reversible reaction begins. In this process, lignin reacts with another lignin molecule at the carbonyl carbon to release a glycol or diol corresponding to the cyclic alkyl carbonate (e.g., propylene glycol resulting from propylene carbonate) as illustrated in Scheme 5. These glycols formed are typically removed under vacuum or reduced pressure. The transesterification reaction results in a significant reduction in total hydroxyl value of the final lignin polyol, and thus this is a means to select or control the hydroxyl value of the lignin polyol for a particular end use (e.g., reaction time/extent of reaction selected to provide a hydroxyl value desired for forming a given foam, elastomer, coating, adhesive, etc. final product). The reaction under vacuum is suitably about 1 hour or less to avoid producing too viscous lignin polyols.

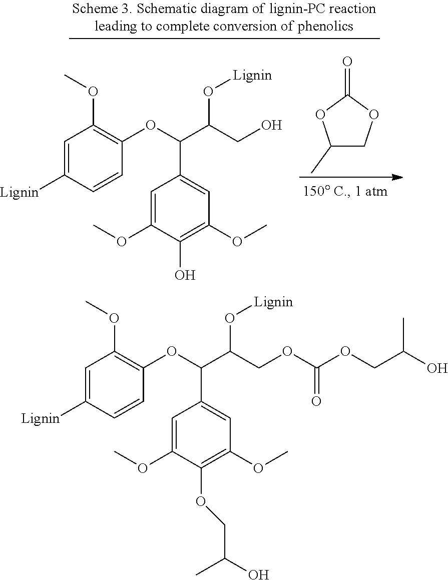

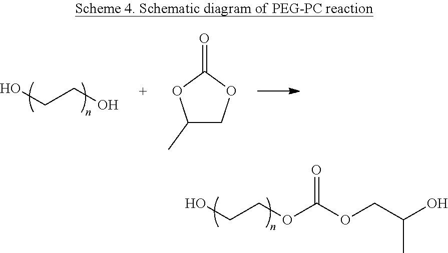

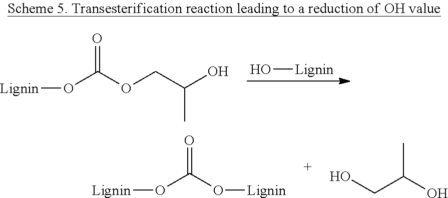

The unreacted cyclic alkyl carbonate remaining in the reaction product is suitably low, for example not more than 30 wt. % relative to total (or original) cyclic alkyl carbonate added to the reaction mixture, for example at least 0.1, 1, 2, 5, 10, or 15 wt. %. and/or up to 15, 20, 25, or 30 wt. % of cyclic alkyl carbonate is unreacted. Alternatively, the oxyalkylation reaction can have 70-99.9, 80-98, or 85-95 wt. % conversion of cyclic alkyl carbonate. Inclusion of the polyol reactive co-solvent provides an additional reactant for the cyclic alkyl carbonate to improve carbonate consumption/conversion or remove unreacted alkyl carbonate in addition to that reacted via the oxyalkylation reaction, leaving less unreacted cyclic alkyl carbonate in the product mixture, which can cause problems (e.g., acting as a plasticizer and non-reactive components in the foam resulting in weight loss) in subsequent process steps such as PU formation, etc. Without the polyol reactive co-solvent and under otherwise comparable reaction conditions, unreacted cyclic alkyl carbonate can be as high as about 50-70 wt. %.

The cyclic alkyl carbonate, lignin, and polyol reactive co-solvent can be present in the reaction mixture in a variety of relative amounts, for example representing an initial reaction mixture, the reaction mixture prior to addition of catalyst, and/or the reaction mixture prior to the oxyalkylation reaction. In embodiments, the cyclic alkyl carbonate can be present in the reaction mixture in an amount of 10-50 wt. %, for example at least 10, 20, 25, or 30 wt. % and/or up to 20, 30, 35, 40, 45, or 50 wt. %. In embodiments, the lignin can be present in the reaction mixture in an amount of 10-50 wt. %, for example at least 10, 20, 25, or 30 wt. % and/or up to 20, 30, 35, 40, 45, or 50 wt. %. In embodiments, the polyol can be present in the reaction mixture in an amount of 10-50 wt. %, for example at least 10, 20, 25, or 30 wt. % and/or up to 20, 30, 35, 40, 45, or 50 wt. %.

In some embodiments, the method for forming the oxyalkylated lignin polyol can be extended by performing a transesterification reaction with a dialkyl carbonate. The dialkyl carbonate can be added to the reaction medium before, during, or after the formation of the oxyalkylated lignin polyol reaction product. The dialkyl carbonate can react with one or both of the oxyalkylated lignin polyol and the ring-opened adduct of the polyol and the cyclic alkyl carbonate, thereby forming a plurality of carbonate adducts with the lignin and the polyol, and an alcohol corresponding to the dialkyl carbonate. Example carbonate adducts can be represented by [HO—R]—[OC(═O)O]—[R—OH], [HO—R]—[OC(═O)O]-[L-OH], [HO-L]-[OC(═O)O]-[L-OH], and/or units thereof (e.g., multiple carbonate groups with intervening R or L groups), where R is an alkylene residue from the polyol and L is a lignin residue. The alcohol is generally an alcohol corresponding to the alkyl group(s) of the dialkyl carbonate corresponding to the dialkyl carbonate, for example methanol formed when using dimethyl carbonate, or ethanol formed when using diethyl carbonate.

Scheme 6 and Scheme 7 illustrate representative reactions and steps for a generic polyol reactive co-solvent (HO—R₁—OH, where R₁ is the alkylene unit), a generic lignin residue (illustrated by a o-methoxyphenol unit prior to reaction, and L or an oxyalkylated o-methoxyphenol unit after reaction), propylene carbonate as a representative cyclic alkyl carbonate, and dimethyl carbonate as a representative dialkyl carbonate. Scheme 6 illustrates the initial formation of a ring-opened adduct of the polyol and the cyclic alkyl carbonate (top) and an oxyalkylated lignin polyol (bottom) as generally described above. Scheme 7 illustrates the subsequent transesterification reaction with the dialkyl carbonate to form various carbonate adducts with the lignin and the polyol, including (1) adducts with (only) polyol reactive co-solvent residues, (2) adducts with both polyol reactive co-solvent and oxyalkylated lignin polyol residues, and (3) adducts with (only) oxyalkylated lignin polyol residues. Although not shown in Scheme 7, the product mixture can include poly-carbonate adducts combining the units from adducts (1), (2), and (3), for example including 1, 2, 3, 4, 5, 6, or more carbonate groups with intervening R or L groups and terminal OH groups (i.e., still forming a diol adduct as a product). Apart from the three possible repeating units formed after the transesterification reaction (Scheme 7), other oligomeric diols are generally not formed. Residual alcohol byproducts (e.g., methanol or ethanol depending on starting dialkyl carbonate) are formed, and can and later distilled under vacuum to obtain the final polyol products represented by adducts (1), (2), (3), and/or combinations thereof.

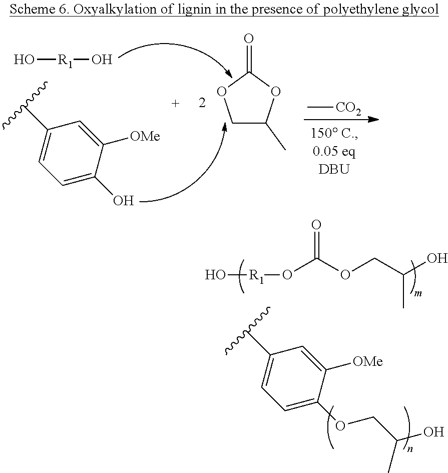

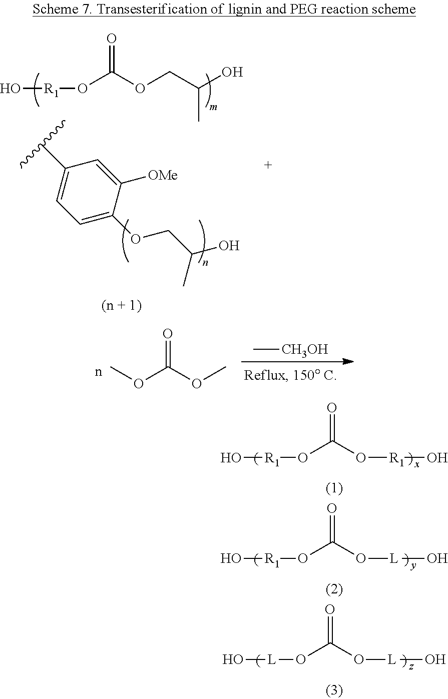

In embodiments, the dialkyl carbonate can be present, for example added to reaction mixture, in an amount in a range of 0.2 eq. to 2 eq. relative to total hydroxy content (e.g., in mmol OH/g) in the reaction mixture after the oxyalkylation reaction. The total hydroxy content can include one or more of the oxyalkylated lignin polyol, the ring-opened adduct of the polyol and the cyclic alkyl carbonate, and any unreacted polyol. More generally, the dialkyl carbonate can be present in an amount of at least 0.2, 0.3, 0.5, 0.7, or 1 eq. and/or up to 0.8, 0.85, 0.9, 0.95, 1, 1.2, 1.5, 1.7, or 2 eq. Alternatively or additionally, the dialkyl carbonate can be present in an amount of about 10-50 or 20-40 wt. % relative to the dialkyl carbonate and the oxyalkylated lignin polyol relative combined at the beginning of the transesterification reaction. Similarly, the oxyalkylated lignin polyol carbonate can be present in an amount of about 50-90 or 60-80 wt. % relative to the dialkyl carbonate and the oxyalkylated lignin polyol relative combined at the beginning of the transesterification reaction. The equivalents can correspond to the moles of dialkyl carbonate (i.e., for 1 mmol/g of total hydroxyl group of oxyalkylation product, 0.5 eq. mole of dialkyl carbonate is required). A dialkyl carbonate equivalent ratio less than 1 can be selected to obtain a polyol with terminal hydroxy (OH) group. Varying the equivalent ratio helps control the chain length and hydroxyl value of the final polyol. Higher ratios will result in a high molecular weight and low hydroxyl value polyol, which in turn can undesirably produce a high viscosity polyol. Nonetheless, dialkyl carbonate equivalent ratios can be selected to control the hydroxyl value of the final polyol for different embodiments in which an intended end use could benefit from a relatively higher or relatively lower hydroxyl value.

In embodiments, the method further includes removing at least a portion of the alcohol formed during the transesterification reaction from a reaction vessel for the transesterification reaction. This can include distilling or otherwise removing alcohol formed and vaporized during transesterification. Additionally, a distillation or removal step also can remove unreacted dialkyl carbonate.

In embodiments, the method includes performing the transesterification reaction at a temperature in a range of 80-200° C., for example at least 80, 100, 120, 140, or 160° C. and/or up to 125, 150, 175, or 200° C. In embodiments, the method includes performing the transesterification reaction for time of 0.1-2 hr, for example at least 0.1, 0.2, or 0.3 hr and/or up to 0.4, 0.6, 0.8, 1, 1.5, or 2 hr. The reaction time can be selected to control viscosity of final product. In embodiments, the method includes performing the transesterification reaction at a pressure in a range of 0.5 to 2 bar, for example at least 0.5, 0.7, 0.8, 0.9, 0.95 bar and/or up to 1.05, 1.1, 1.2, 1.3, 1.5, 1.7, or 2 bar, such as approximately atmospheric pressure. In other embodiments, the transesterification can be performed under the general reaction conditions described below for the oxyalkylation reaction.

### Oxyalkylation at Reduced Pressure

In an aspect, the oxyalkylated lignin polyol can be formed from a reaction mixture (e.g., initial reaction mixture) including a cyclic alkyl carbonate, a lignin, and an oxyalkylation catalyst. The corresponding oxyalkylation reaction (e.g., upon sufficient heating) reacts the cyclic alkyl carbonate with the lignin to form an oxyalkylated lignin polyol reaction product. Subsequently, a transesterification reaction is performed at reduced pressure to react the oxyalkylated lignin polyol with one or both of lignin and oxyalkylated lignin polyol. The transesterification reaction forms a diol corresponding to the cyclic alkyl carbonate, such as propylene glycol being formed when using propylene carbonate.

The transesterification reaction can be performed under a vacuum or at a sufficiently low pressure such that the transesterification reaction temperature is sufficient to remove the formed diol via distillation from reaction product. For example, transesterification reaction can be performed at a pressure in a range of 0.001 bar to 0.5 bar, such as at least 0.001, 0.01, 0.1, 0.2, or 0.3 bar and/or up to 0.2, 0.3, 0.4, or 0.5 bar.

In embodiments, the method includes removing at least a portion of the diol formed during the transesterification reaction from a reaction vessel for the transesterification reaction. For example, the method can include distilling or otherwise removing diol formed and vaporized during transesterification. The removed diol can be used in a downstream process, for example as a co-reactant in a polyurethane or polyester formation process.

In embodiments, the method includes performing the transesterification reaction at a temperature in a range of 100-200° C. or 80-200° C., for example at least 80, 100, 120, 140, or 160° C. and/or up to 125, 150, 175, or 200° C. In embodiments, the method includes performing the transesterification reaction for time of 0.1-1 hr, or example at least 0.1, 0.2, or 0.3 hr and/or up to 0.4, 0.6, 0.8, or 1 hr. The reaction time can be selected to control viscosity of final product. In other embodiments, the transesterification can be performed under the general reaction conditions described below for the oxyalkylation reaction.

Oxyalkylation with Solubilized Lignin

In an aspect, the oxyalkylated lignin polyol can be formed from a reaction mixture (e.g., initial reaction mixture) including a cyclic alkyl carbonate, a lignin, and an oxyalkylation catalyst. The corresponding oxyalkylation reaction (e.g., upon sufficient heating) reacts the cyclic alkyl carbonate with the lignin to form an oxyalkylated lignin polyol reaction product. The lignin, prior to reaction and/or incorporation in the reaction mixture, is selected to provide an oxyalkylated lignin polyol with relatively low viscosity and good solubility or miscibility with other co-polyols (e.g., which could be added to the reaction product for a subsequent polyurethane synthesis). For example, the lignin can be selected (e.g., based on its biomass source and/or isolation/extraction technique) such that it has at least one of the following properties: a molecular weight in a range of 500 to 10000; a polydispersity in a range of 1.2 to 5 (e.g., 1.2 to 3); an aliphatic hydroxyl content in a range of 0.5 to 7 mmol/g; a phenol hydroxyl content in a range of 1 to 7 mmol/g (e.g., more generally at least 1, 2, 3, 4, 5, or 6 mmol/g and/or up to 4, 5, 6, 7, 8, or 9 mmol/g); a carboxylic hydroxyl content less than 1 mmol/g; and a total hydroxyl content in a range of 2 to 10 mmol/g. In embodiments, the various lignin properties can be selected within the various ranges and subranges described below for the lignin.

In embodiments, the lignin is completely soluble in a reaction mixture containing (i) 10-50 wt. % cyclic alkyl carbonate, (ii) 10-50 wt. % lignin, and (iii) 10-50 wt. % polyol reactive co-solvent (e.g., with same sub-ranges as described above). The polyol reactive co-solvent can solubilize some minor amounts of lignin components not soluble in the cyclic alkyl carbonate, thus providing a more complete reaction and lowering the cyclic alkyl carbonate needed for the reaction medium. In embodiments, the cyclic alkyl carbonate can be present in the reaction mixture in an amount in a range of 1 eq to 5 eq relative to the lignin hydroxyl content, for example at least 1, 1.2, 1.5, 1.7, 2, 2.5, 3, 3.5, or 4 eq and/or up to 2, 2.5, 3, 4, or 5 eq relative to the lignin hydroxyl content.

In embodiments, the lignin can include an acetone-soluble lignin fraction, for example an acetone-soluble fraction of kraft lignin. Alternatively, other fractionation methods can be used to obtain a lower-molecular weight fraction with a higher phenolic hydroxyl content, such as at least 0.5-5 or 1-3 mmol/g or higher phenolic hydroxyl content, relative to the original lignin to promote solubility.

Oxyalkylation with a Polyol Reactive Co-Solvent and Dialkyl Carbonate

In an aspect, the oxyalkylated lignin polyol can be formed from a reaction mixture (e.g., initial reaction mixture) including a dialkyl carbonate, a polyol reactive co-solvent, and an oxyalkylation catalyst, for example without any substantial amount of lignin initially present (e.g., not more than 1, 0.1, 0.01, 0.001 wt. % lignin present in the initial reaction mixture). A first transesterification reaction is performed to react the dialkyl carbonate with the polyol, thereby forming a carbonate-terminated derivative of the polyol. The carbonate-terminated derivative of the polyol can be represented by [R¹]—[OC(═O)O]—R—[OC(═O)O]—[R¹] and/or units thereof (e.g., three or more carbonate groups with intervening R groups), where R is an alkylene residue from the polyol and R¹ is an alkyl group from the dialkyl carbonate. For example, R can be an ethylene residue and R¹ can be methyl, for PEG as the polyol and dimethyl carbonate as the dialkyl carbonate, respectively. The first transesterification reaction also forms an alcohol corresponding to the dialkyl carbonate (e.g., methanol formed when using dimethyl carbonate, ethanol formed when using diethyl carbonate). A second transesterification reaction is performed to react a lignin, which can be added to reaction medium before, during, or after formation of the carbonate-terminated derivative of the polyol, thereby reacting the carbonate-terminated derivative of the polyol with the lignin. The resulting product is thereby forming a polycarbonate oxyalkylated lignin polyol, for example being represented by [HO-L]-[OC(═O)O]—{R—[OC(═O)O]-L}ₙ-[OH], where R is an alkylene residue from the polyol, L is a lignin residue, and n is 1, 2, 3, 4, 5, 6, 7, 8, 9, 10, up to 20, or combinations thereof in a distribution of reaction products with different numbers of carbonate groups.

Scheme 8 illustrates representative reactions and steps for a generic polyol reactive co-solvent (HO—R₁—OH, where R₁ is the alkylene unit), a generic lignin residue (illustrated by L), and dimethyl carbonate as a representative dialkyl carbonate. Scheme 8 illustrates the initial formation of the carbonate-terminated derivative of the polyol by reaction between the polyol and the dialkyl carbonate (top row). Scheme 8 also illustrates the subsequent formation of the polycarbonate oxyalkylated lignin polyol by reaction between the carbonate-terminated derivative of the polyol and lignin (e.g., including at least some aliphatic hydroxy groups) (right side).

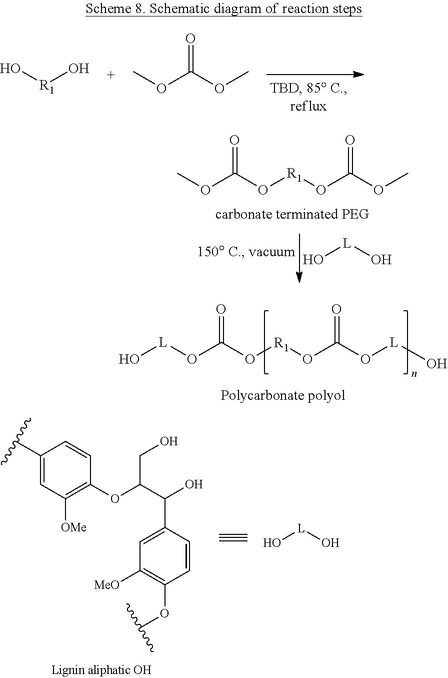

In embodiments, the method further includes removing at least a portion of the alcohol formed during the first transesterification reaction from a reaction vessel for the first transesterification reaction. This can include distilling or otherwise removing alcohol formed and vaporized during transesterification, such as before the transesterification reaction. Additionally, a distillation or removal step also can remove unreacted dialkyl carbonate.

In embodiments, the method includes performing the first transesterification reaction at a temperature in a range of 80-200° C., for example at least 80, 100, 120, 140, or 160° C. and/or up to 125, 150, 175, or 200° C. In embodiments, the method includes performing the first transesterification reaction for time of 0.1-4 hr, for example at least 0.1, 0.2, or 0.3 hr and/or up to 0.4, 0.6, 0.8, 1, 1.5, 2, 3, or 4 hr. In other embodiments, the first transesterification can be performed under the general reaction conditions described below for the oxyalkylation reaction.

In embodiments, the method includes performing the second transesterification reaction at a temperature in a range of 80-200° C., for example at least 80, 100, 120, 140, or 160° C. and/or up to 125, 150, 175, or 200° C. In embodiments, the method includes performing the second transesterification reaction for time of 0.1-4 hr, for example at least 0.1, 0.2, or 0.3 hr and/or up to 0.4, 0.6, 0.8, 1, 1.5, 2, 3, or 4 hr. In embodiments, the method includes performing the second transesterification reaction at a pressure in a range of 0.001 bar to 0.5 bar. More generally, the second transesterification can be performed under a vacuum or at a sufficiently low pressure for the transesterification reaction temperature to remove the formed alcohol (e.g., methanol, ethanol) via distillation from reaction product, such as at least 0.001, 0.01, 0.1, 0.2, or 0.3 bar and/or up to 0.2, 0.3, 0.4, or 0.5 bar. In other embodiments, the second transesterification can be performed under the general reaction conditions described below for the oxyalkylation reaction.

In embodiments, the dialkyl carbonate can be present in the reaction mixture in an amount of 20-80 wt. %, for example at least 20, 30, 35, or 40 wt. % and/or up to 30, 40, 50, 60, 70, or 80 wt. %. In embodiments, the polyol can be present in the reaction mixture in an amount of 20-80 wt. %, for example at least 20, 30, 35, or 40 wt. % and/or up to 30, 40, 50, 60, 70, or 80 wt. %. In some embodiments, the reaction mixture is free from or otherwise does not contain more than 1, 2, 4, 8, or 10 wt. % components other than the dialkyl carbonate and the polyol in the (initial) reaction mixture.

In embodiments, in or during the second transesterification reaction, the lignin can be present in an amount of 10-70 wt. %, for example at least 10, 20, 25, or 30 wt. % and/or up to 20, 30, 35, 40, 45, 50, 60, or 70 wt. % relative to a combined amount of the lignin and the carbonate-terminated derivative of the polyol. In embodiments, in or during the second transesterification reaction, the carbonate-terminated derivative of the polyol can be present in an amount of 30-90 wt. %, for example at least 30, 40, 45, or 50 wt. % and/or up to 40, 50, 55, 60, 65, 70, 80, or 90 wt. %. In some embodiments, the reaction mixture is free from or otherwise does not contain more than 1, 2, 4, 8, or 10 wt. % components other than the lignin and the carbonate-terminated derivative of the polyol during the second transesterification reaction.

In embodiments, the polyol reactive co-solvent can be a poly(alkylene oxide) diol, for example with the same options and alternatives as generally described herein. In embodiments, the dialkyl carbonate can be at least one of dimethyl carbonate and diethyl carbonate, for example with the same options and alternatives as generally described herein.

In embodiments, the dialkyl carbonate can be present, for example as added to reaction mixture, in an amount in a range of 1 eq. to 3 eq. relative to total hydroxy content (e.g., in mmol OH/g) in the reaction mixture before the first transesterification reaction (e.g., total hydroxy content of the initial polyol reactive co-solvent). More generally, the dialkyl carbonate can be present in an amount of at least 1, 1.5, 1.8, 1.9, or 2 eq. and/or up to 2, 2.1, 2.2, 2.3, 2.4, 2.5, 2.7, or 3 eq. in the reaction mixture relative to total hydroxy content of the initial polyol reactive co-solvent.

Oxyalkylation with Added Water

In an aspect, the oxyalkylated lignin polyol can be formed from a reaction mixture (e.g., initial reaction mixture) including a cyclic alkyl carbonate, a lignin, and an oxyalkylation catalyst. The corresponding oxyalkylation reaction (e.g., upon sufficient heating) reacts the cyclic alkyl carbonate with the lignin to form an oxyalkylated lignin polyol reaction-opening reaction. Subsequently, a ring-opening reaction is performed with water, for example with the water being added to reaction medium before, during, or after formation of the oxyalkylated lignin polyol reaction product. The ring-opening reaction reacts the water with the unreacted excess cyclic alkyl carbonate, thereby forming a polycarbonate alkylene polyol. The polycarbonate alkylene polyol can be represented by [HO—R]—{[OC(═O)O]—R}ₙ—[OH], where R is an alkylene residue from the cyclic alkyl carbonate, and n is 1, 2, 3, 4, 5, 6, 7, 8, 9, 10, up to 20, or combinations thereof in a distribution of reaction products with different numbers of carbonate groups. The inclusion of water for the ring-opening reaction can be useful to provide a oxyalkylated lignin polyol with a relatively high hydroxyl-value, which in turn can be substantially as is to form a rigid polyurethane foam (e.g., with addition of isocyanate but without necessarily adding other polyols), since the oxyalkylated lignin polyol and the polycarbonate alkylene polyol can provide sufficient hydroxyl functionality for polyurethane formation. Scheme 9 illustrates the ring-opening reaction with water and propylene carbonate as a representative cyclic alkyl carbonate.

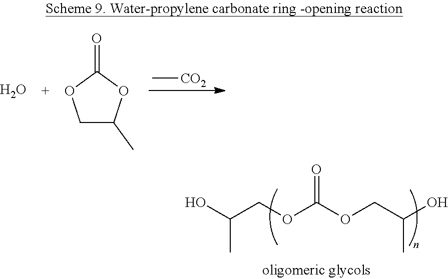

In embodiments, at least some unreacted excess cyclic alkyl carbonate remains after the ring-opening reaction. For example, the final reaction medium after the ring-opening reaction can contain the oxyalkylated lignin polyol, the polycarbonate alkylene polyol, and cyclic alkyl carbonate, which can be used directly for formation of a rigid foam. A suitable distribution of components in the final reaction medium can include about 25-55, 30-50, or 35-45 wt. % oxyalkylated lignin polyol, about 15-45, 20-40, or 25-35 wt. % polycarbonate alkylene polyol, and about 15-45, 20-40, or 25-35 wt. % cyclic alkyl carbonate relative to the final reaction medium. Suitably, the final reaction medium contains not more than 0.1, 1, 2, 5, 7, or 10 wt. % of components other than the oxyalkylated lignin polyol, the polycarbonate alkylene polyol, and cyclic alkyl carbonate, relative to the final reaction medium.

In embodiments, the reactive co-solvent can be a poly(alkylene oxide) diol, for example with the same options and alternatives as generally described herein.

In embodiments, the method includes performing the oxyalkylation reaction at a temperature in a range of 80-200° C., for example at least 80, 100, 120, 140, or 160° C. and/or up to 125, 150, 175, or 200° C. In embodiments, the method includes performing the oxyalkylation reaction for time of 0.1-4 hr, for example at least 0.1, 0.2, or 0.3 hr and/or up to 0.4, 0.6, 0.8, 1, 1.5, 2, 3, or 4 hr. In other embodiments, the oxyalkylation reaction can be performed under the general reaction conditions described below for the oxyalkylation reaction.

In embodiments, the method includes performing the ring-opening reaction at a temperature in a range of 80-200° C., for example at least 80, 100, 120, 140, or 160° C. and/or up to 125, 150, 175, or 200° C. In embodiments, the method includes performing the ring-opening reaction for time of 0.1-4 hr, for example at least 0.1, 0.2, or 0.3 hr and/or up to 0.4, 0.6, 0.8, 1, 1.5, 2, 3, or 4 hr. In other embodiments, the ring-opening reaction can be performed under the general reaction conditions described below for the oxyalkylation reaction.

In embodiments, the cyclic alkyl carbonate can be present in the reaction mixture in an amount of 50-90 wt. %, for example at least 50, 60, 65, or 70 wt. % and/or up to 60, 70, 75, 80, 85, or 90 wt. %). In embodiments, the lignin can be present in the reaction mixture in an amount of 10-50 wt. %, for example, at least 10, 20, 25, or 30 wt. % and/or up to 20, 30, 40, or 50 wt. %. In some embodiments, the reaction mixture is free from or otherwise does not contain more than 1, 2, 4, 8, or 10 wt. % components other than the cyclic alkyl carbonate and the lignin in the (initial) reaction mixture.

In embodiments, the cyclic alkyl carbonate can be present, for example as added to reaction mixture, in an amount in a range of 1.5 eq. to 8 eq. relative to total hydroxy content (e.g., in mmol OH/g) in the reaction mixture before the oxyalkylation reaction (e.g., total hydroxy content of the initial lignin). More generally, the cyclic alkyl carbonate can be present in an amount of at least 1.5, 2, 2.5, 3, 3.5, or 4 eq. and/or up to 2, 2.5, 3, 3.5, 4, 4.5, 5, 6, 7, or 8 eq., such as where 1 eq. of lignin total hydroxyl content corresponds to 4 eq. mole of alkylene carbonate, expressed in mmol/g or otherwise.

### Cyclic Alkyl Carbonate

The cyclic alkyl carbonate is not particularly limited and can include any cyclic structure including a carbonate group (—OC(═O)O—) linked to an alkyl hydrocarbon group at both carbonate oxygen atoms, thus forming a cyclic structure from five or more atoms (e.g., one carbonyl carbon atom, two carbonate oxygen atoms, and at least two alkyl carbon atoms). The cyclic alkyl carbonate suitably is in liquid form both at lower ambient temperatures (e.g., room temperature or about 20-30° C.) and/or at higher temperatures that may be useful reaction temperatures for prepolymerization and/or curing. For example, propylene carbonate has a melting point of −49° C. and a boiling point of 242° C. Similarly, ethylene carbonate has a melting point of 35° C. and a boiling point of 243° C., so it would be useful, for example, in a high-temperature formulation (i.e., where it is in liquid form) or in liquid solution with another cyclic alkyl carbonate that is liquid at lower ambient temperatures, such as propylene carbonate. The cyclic alkyl carbonate further suitably serves as a solvent for the lignin, thus assisting water removal via solubilization of the lignin and release of the lignin's water into the liquid cyclic alkyl carbonate (e.g., as a dispersed aqueous phase) for subsequent removal via heating or distillation. Different lignins have varying solubilities in the cyclic alkyl carbonate medium. For example, organosolv lignins are soluble in propylene carbonate at room temperature, while other lignins such as kraft are soluble in propylene carbonate at higher temperatures of about 100-120° C. In either case, the lignin is solubilized at temperatures suitable for water removal via heating.

In embodiments, the cyclic alkyl carbonate can have an alkyl group containing from 2 to 20 carbon atoms. For example, the cyclic alkyl carbonate can have at least 2, 3, 4, 5, or 6 and/or up to 3, 4, 5, 6, 8, 10, 12, 15, or 20 carbon atoms. The alkyl group can be linear or branched and/or substituted or unsubstituted. The alkyl group and the corresponding cyclic alkyl carbonate preferably does not include any free hydroxyl groups, free amine groups, and/or free carboxylic acid/carboxylate groups (e.g., when the alkyl group is a substituted group). The alkyl group does not include the carbon atom in the carbonyl group of the carbonate. Thus, the cyclic alkyl carbonate has 3 to 21 total carbon atoms in this embodiment. The alkyl group can be linked to the carbonate group oxygen atoms at adjacent carbon atoms (e.g., as in propylene carbonate with a 3-carbon alkyl group or ethylene carbonate with a 2-carbon alkyl group) or at non-adjacent carbon atoms (e.g., as in trimethylene carbonate with a 3-carbon alkyl group).

In embodiments, the cyclic alkyl carbonate has a structure according to Formula I illustrated below. In Formula I, n is 1 to 10; i is each of 1 to n; and Rᵢ, R′ᵢ, Rₙ₊₁, and R′ₙ₊₁ are independently selected from H and linear or branched, substituted or unsubstituted C₁-C₁₀ alkyl groups. In the illustrated Formula I, the index n can be a single value from 1 to 10, such as 1, 2, or 3, for example at least 1, 2, or 3 and/or up to 2, 4, 6, 8, or 10. The index i takes all of the values from 1 to n for a given value of n (i.e., there are “i” groups for each of the n+1 total carbons in the ring). Rᵢ, R′ᵢ, Rₙ₊₁, and R′ₙ₊₁ can independently be H or linear or branched, substituted or unsubstituted C₁-C₁₀ alkyl groups, such as alkyl groups with 1, 2, or 3 carbons, for example at least 1, 2, or 3 and/or up to 2, 4, 6, 8, or 10 carbons. Substituents for substituted alkyl groups are generally not limited, but preferably do not include isocyanate-reactive groups such as hydroxyl groups, amine groups (e.g., primary, secondary), and carboxylic acid/carboxylate groups. For example, if n=2, then the structure of Formula I will have R₁, R′₁, R₂, R′₂, R₃, and R′₃ substituents, which can be independently selected to be hydrogen atoms or the alkyl groups noted above. Examples of suitable cyclic alkyl carbonates include propylene carbonate, ethylene carbonate, trimethylene carbonate, butylene carbonates (e.g., derived from one or more butanediols such as 1,2-, 1,3-, 1,4-, or 2,3-butanediol), pentylene carbonates (e.g., derived from one or more pentanediols), etc. In the context of the structure of Formula I for propylene carbonate, n is 1; R₁, R′₁, and R′₂ are H; and R₂ is CH₃. For ethylene carbonate, n is 1; and R₁, R′₁, R₂, and R′₂ are H. For trimethylene carbonate, n is 2; and R₁, R′₁, R₂, R′₂, R₃, and R′₃ are H.

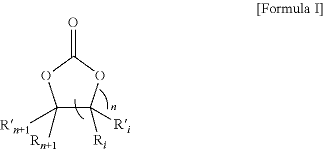

The cyclic alkyl carbonate can be added to the reaction mixture in controlled or selected amount (e.g., relative to the lignin) in order to obtain an oxyalkylated lignin polyol product with one or more of a desired aliphatic hydroxyl content (e.g., mmol aliphatic OH/g), overall hydroxy value (e.g., mg KOH/g), and/or viscosity (e.g., cP measured at 25° C.). In embodiments, the cyclic alkyl carbonate can be added to or present in the reaction mixture in an amount in a range of 2 eq to 10 eq relative to the lignin hydroxyl content. For example, the cyclic alkyl carbonate can be present in the reaction mixture in an amount of at least 2, 2.5, 3, 3.5, 4, or 5 eq and/or up to 3, 4, 5, 6, 7, 8, or 10 eq relative to the lignin hydroxyl content. The molar equivalent “eq” unit represents in this case moles of cyclic alkyl carbonate molecules or moles of total hydroxyl (—OH) groups initially in the lignin, which represents the sum of phenolic/aromatic hydroxyl, aliphatic hydroxyl groups, and carboxylic acid hydroxyl groups initially in the lignin. Alternatively or additionally, the content of the reaction mixture can be expressed on a weight basis, for example containing 50-95 wt. % (e.g., at least 50, 60, or 70 wt. % and/or up to 70, 80, 90, or 95 wt. %) cyclic alkyl carbonate and 5-50 wt. % lignin (e.g., at least 5, 10, 15, 20, or 25 wt. % and/or up to 20, 30, 40, or 50 wt. %) (dry weight basis) based on the combined amount of cyclic alkyl carbonate and lignin (dry weight basis). There is generally no need to add solvents or other components to the reaction mixture, such that the (initial) reaction mixture is typically at least 95, 98, 99, or 99.5 wt. % of cyclic alkyl carbonate, lignin, and water combined, based on the combined weight of the reaction mixture.

### Dialkyl Carbonate

The dialkyl carbonate can be represented by R¹—[OC(═O)O]—R², where R¹ and R² can be the same or different, for example a linear, branched, or cyclic unsubstituted or substituted alkyl group. In embodiments, the alkyl groups of the dialkyl carbonate (e.g., R¹ and R²) each can independently have 1, 2, 3, 4, 5, or 6 carbon atoms. Examples of suitable dialkyl carbonates include dimethyl carbonate and diethyl carbonate.

The alcohol formed as a transesterification byproduct from the dialkyl carbonate is generally an alcohol corresponding to the alkyl groups of the dialkyl carbonate. With the dialkyl carbonate represented by R¹—[OC(═O)O]—R² as described above, the corresponding alcohols can be represented by R¹—OH and R²—OH, which can be the same or different depending on the starting dialkyl carbonate. For example, methanol and ethanol are transesterification byproducts formed from dimethyl carbonate and diethyl carbonate, respectively.

### Polyol Reactive Co-Solvent

The polyol reactive co-solvent is not particularly limited and can include a wide variety of polyols that can react with the cyclic alkyl carbonate, help to maintain the lignin in solution (i.e., reducing or preventing lignin precipitation), and/or help to maintain the final product viscosity within desired limits. In some embodiments, the polyol can be a poly(alkylene oxide) diol, for example polyethylene glycol (PEG), polypropylene glycol (PPG), or other polyalkylene glycol with 2, 3, 4, 2-10, or 4-8 carbon atoms in the alkylene group. More generally, the polyol can include any hydrocarbon with two hydroxyl groups (diol), three hydroxyl groups (triol), or four or more hydroxyl groups. The polyol can include monomeric or small molecule polyols such as glycerin, ethylene glycol, etc. The polyol can include oligomeric or polymeric polyols such as polyether polyols, polyester polyols, poly(alkylene oxide) polyols. The polyol is generally liquid at ambient temperatures (e.g., 20-25° C.). The polyol is suitably biobased, such as biobased PEG or short oligomers such as diethylene glycol, triethylene glycol, tetraethylene glycol, etc.

In embodiments, the polyol reactive co-solvent can have a molecular weight in a range of 50-5000 g/mol. For example, the molecular weight can be at least 50, 75, 100, 200, 300, 400, 500, or 700 g/mol and/or up to 100, 150, 200, 300, 400, 500, 700, 1000, 1500, 2000, 3000, or 5000 g/mol. The foregoing values can represent a molecular weight for a small molecule, or they can represent a number-average molecular weight (Mn) or weight-average molecular weight (Mw) for an oligomeric or polymeric polyol.

### Lignin

The lignin is not particularly limited and generally can include lignin from any lignocellulosic biomass. Plants, in general, are comprised of cellulose, hemicellulose, lignin, extractives, and ash. Lignin typically constitutes 15-35 wt. % of woody plant cell walls, is an amorphous aromatic polymer made of phenylpropane units (e.g., coniferyl alcohol, sinapyl alcohol, p-coumaryl alcohol). The lignin for use according to the disclosure is not particularly limited to the source of lignin or its isolation method. Any type of lignin regardless of the biomass type (hardwood, softwood, grasses, and other agricultural residues) isolated through any extraction methods (such as Kraft, soda, organosolv, sulfite, enzymatic hydrolysis, ionic liquid, sulfite) is suitable for use in the disclosed compositions and articles.

The lignin incorporated into the reaction mixture for oxyalkylation is generally an unmodified lignin. Unmodified lignin as used herein refers to lignin that has been separated from other components of its lignocellulosic biomass feedstock, such as the cellulose, hemicellulose, and other plant material components. Such separation processes (e.g., Kraft, soda, organosolv, sulfite, enzymatic hydrolysis, and ionic liquid) to isolate lignin from biomass may hydrolyze or otherwise fragment larger lignin molecules into smaller fragments, but this fragmentation and molecular weight reduction is still considered to provide an unmodified lignin as used herein in the corresponding compositions and methods. Such isolated lignins, which are also known as technical lignins, have not been subjected to further modifications or fragmentations, and are considered to provide an unmodified lignin as used herein in the corresponding compositions and methods. Modifications (or chemical modifications) that are generally avoided for the lignin used herein can include one or more of demethylation, phenolation, hydroxymethylation, etherification, depolymerization, and fractionation to monomer, dimers, trimers and oligomers.

The unmodified lignin is generally polymeric, as contrasted with various lignin monomers such as one or more of coniferyl alcohol, sinapyl alcohol, and p-coumaryl alcohol. For example, the unmodified lignin can have an average molecular weight (e.g., weight-average molecular weight, Mw) of at least 500 g/mol or at least 1000 g/mol. While technical lignins or other commercial lignins isolated from biomass could have some lignin monomers in the distribution of lignin components, the fraction of such lignin monomers in the unmodified lignin is suitably small, for example as reflected by the minimum average molecular weight of the unmodified lignin. In some embodiments, the unmodified lignin contains less than 10, 5, 2, 1, 0.5, 0.2, or 0.1 wt. % lignin monomers relative to the total unmodified lignin.

In embodiments, the (unmodified) lignin, prior to incorporation into the reaction mixture, can have at least one of the following properties: a molecular weight in a range of 500 to 20000; a polydispersity in a range of 1.2 to 8; an aliphatic hydroxyl content in a range of 1 to 4 mmol/g; a phenol hydroxyl content in a range of 2 to 5 mmol/g; a carboxylic hydroxyl content less than 1 mmol/g; and a total hydroxyl content in a range of 3 to 9 mmol/g.

In embodiments, the (unmodified) lignin, prior to incorporation into the reaction mixture, can have the following properties: a number-average molecular weight (Mn) in a range of 500 to 5000 (or 1000 to 3000); a polydispersity in a range of 1.2 to 8 (or 2 to 4); a phenol hydroxyl content in a range of 1 to 7 mmol/g (or 2 to 5 mmol/g); a relative phenol hydroxyl content of at least 45% (or at least 55%) relative to hydroxyl groups of the unmodified lignin; and a carboxylic hydroxyl content less than 1 mmol/g (or less than 0.5 mmol/g).

More generally, the (unmodified) lignin, prior to reaction and/or incorporation into a reaction mixture for removal of water, suitably can be selected to have one or more properties related to molecular weight, molecular weight distribution, hydroxyl content, and hydroxyl content distribution. For example, a lower molecular weight and/or a lower polydispersity index can be desirable to promote access to and reactivity of the phenolic (or aromatic) hydroxy groups of the lignin, but lignin with any molecular weight and/or polydispersity can be used. Suitably, the weight-average molecular weight (M_{w}) can be in a range of 500 to 50000, 1000 to 3000, 3000 to 7000, 3000 to 10000, or 10000 to 50000. For example, M_{w} independently can be at least 500, 800, 1000, 1500, 2000, or 3000 and/or up to 1000, 1200, 1500, 2000, 3000, 5000, 7000, 10000, 15000, or 50000, but higher values are possible. Similar ranges can apply to the number-average molecular weight (Mₙ). Alternatively or additionally, the polydispersity index (M_{w}/Mₙ) can be in a range of 1.2 to 10, 1.2 to 8, 1.2 to 5, or 2 to 4, for example being at least 1.2, 1.4, 1.6, 1.8, or 2 and/or up to 1.5, 1.8, 2.0, 3.0, 4.0, 5.0, 6.0, 8.0, or 10, but higher values are possible. In a refinement, the aliphatic hydroxyl content of the unmodified lignin can be in a range of 0.5 to 7 mmol/g, 1 to 4 mmol/g, or 1 to 3 mmol/g, for example being at least 0.5, 1, 1.5 or 2 and/or up to 2, 2.5, 3, 3.5, 4, 5, 6, or 7 mmol/g. In a refinement, the phenol hydroxyl content of the unmodified lignin can be in a range of 1 to 7 mmol/g, 2 to 6 mmol/g, or 3 to 6 mmol/g, for example being at least 1, 1.5, 2, 2.5, 3, or 3.5 and/or up to 3, 3.5, 4, 4.5, 5, 5.5, 6, or 7 mmol/g. Alternatively or additionally, the phenol hydroxyl content can be at least 40, 50, 60, or 70% and/or up to 60, 65, 70, 75, or 80% of the total hydroxyl groups of the unmodified lignin (e.g., aliphatic, phenolic/aromatic, and carboxylic hydroxyl groups combined). Similarly, the phenol hydroxyl content individually can be greater than the aliphatic hydroxyl content individually and the carboxylic hydroxyl content individually. In a refinement, the carboxylic hydroxyl content of the unmodified lignin can be less than 1 mmol/g or 2 mmol/g, for example being at least 0.01, 0.1, or 0.2 and/or up to 0.2, 0.3, 0.4, 0.5, 0.7, 1, 1.5, or 2 mmol/g. In a refinement, the total hydroxyl content of the unmodified lignin can be in a range of 2 to 10 mmol/g, 3 to 9 mmol/g, or 4 to 7 mmol/g, for example being at least 2, 2.5, 3, 3.5, 4, 4.5, or 5 and/or up to 3.5, 4, 4.5, 5, 6, 7, 8, 9, or 10 mmol/g.

In some embodiments, the lignin added to the reaction mixture can be a dried lignin. For example, the lignin initially in or added to the reaction mixture can have a water content of 0.001 wt. % to 5 wt. % relative to the lignin (dry weight basis), such as at least 0.001, 0.01, 0.1 or 1 wt. % and/or up to 0.1, 0.2, 0.3, 0.5, 0.8, 1, 2, 3, 4, or 5 wt. % relative to the lignin (dry weight basis). The various methods known in the art for isolating or extracting lignin from biomass generally result in a lignin material containing a substantial amount of water, for example being adsorbed on or absorbed in fibers or other solid material of the lignin, which can correspondingly be in the form of a moist lignin cake. The presence of water in the lignin, however, can be undesirable for a subsequent oxyalkylation between the lignin and a cyclic alkyl carbonate, because the water can react with catalyst and decrease the yield and efficiency of the reaction. Additionally, the presence of residual water remaining after the formation of the oxyalkylated lignin polyol can undesirably react with a subsequently added isocyanate compound to generate carbon dioxide and foaming instead of a desired polyurethane compound. Accordingly, in some embodiments, the lignin can be dried to remove water prior to being combined with any oxyalkylation reactants or reagents, for example by heating a moist lignin cake in an oven or otherwise by exposure to hot air or other gases.

In some embodiments, the lignin added to the reaction mixture need not be dried before being used in the disclosed methods. For example, the lignin initially in or added to the reaction mixture can have a water content of 5 wt. % to 70 wt. % (e.g., 10 wt. % to 50 wt. %) relative to the lignin (dry weight basis). More generally, the wet lignin initially in or added to the reaction mixture can have a water content of at least 1, 2, 5, 10, 15, 20, 25, 30, 40, or 50 wt. % and/or up to 20, 30, 40, 50, 60, 70, 80, or 100 wt. % relative to the lignin (dry weight basis). Alternatively or additionally, the wet lignin initially in or added to the reaction mixture can have a water content of at least 2, 5, 10, 15, 20, or 25 wt. % and/or up to 20, 30, 40, or 50 wt. % relative to the total of lignin and water (wet weight basis). In such cases and as described below, water initially present in the wet lignin can be removed from the reaction mixture by heating the reaction mixture prior to addition of the oxyalkylation catalyst, for example where the reaction mixture contains one or more of a cyclic alkyl carbonate, a dialkyl carbonate, and a polyol reactive co-solvent in combination with the wet lignin.

### Methods and Oxyalkylated Lignin Polyol Product

As described above, the initial reaction mixture can be formed by any suitable mixing or blending process, such as by adding the lignin directly to a liquid medium including one or more of a cyclic alkyl carbonate, a dialkyl carbonate, a polyol reactive co-solvent, and an oxyalkylation catalyst, for example in the reaction vessel in which the subsequent oxyalkylation will be performed. When the initial reaction mixture also includes water (e.g., as a component of a wet lignin), it can be a multiphase mixture, for example including a liquid carbonate phase (e.g., as a continuous medium) and a water phase (e.g., as a dispersed phase). Depending on the solubility of the lignin in the carbonate, the lignin can be present as a dispersed solid lignin material (e.g., for lignins insoluble in the carbonate at ambient/room temperature) or a solubilized solid lignin material (e.g., for lignins soluble in the carbonate at ambient/room temperature).

In some embodiments, the reaction mixture initially can be substantially free from water, for example when a dried lignin is used as a starting material. For example, the reaction mixture can have a water content of 0.1, 0.2, or 0.5 wt. % or less, relative to the lignin (dry weight basis). In embodiments, the reaction mixture can have a water content of at least 0.001, 0.01, or 0.1 wt. % and/or up to 0.1, 0.2, 0.3, 0.4, 0.5, 0.6, 0.8, or 1 wt. % relative to the lignin (dry weight basis). Alternatively or additionally, the reaction mixture can have a water content of at least 0.0001, 0.001, 0.01, or 0.03 wt. % and/or up to 0.03, 0.05, 0.07, 0.1, 0.15, 0.2, 0.3, or 0.4 wt. % relative to the reaction mixture as a whole.

In some embodiments, the reaction mixture initially can contain water, for example when a wet lignin is used as a starting material. In such cases, the reaction mixture can be dried to eliminate or reduce water content using any suitable heating or distillation process, for example prior to addition of the oxyalkylation catalyst to the reaction mixture (e.g., initially containing less than 0.01, 0.001, 0.0001, or 0.00001 wt. % of any oxyalkylation catalysts, based on the combined or total weight of the reaction mixture). For example, the method can include heating the reaction mixture to remove the water at a temperature in a range of 100° C. to 230° C. The heating more generally is performed at an elevated temperature sufficient to vaporize and remove water from the reaction mixture, but at a temperature low enough to avoid substantial vaporization and removal of the cyclic alkyl carbonate from the reaction mixture. Accordingly, suitable heating temperatures for water removal can be in the range of 100° C. to 230° C., for example at least 100, 120, 130, 150, 170, or 200° C., and/or up to 150, 160, 180, 200, 220, or 230° C., and/or up to a temperature that is 5-20° C., 20-40° C., or 40-60° C. below the boiling point of the cyclic alkyl carbonate. Suitable heating times (or residence times in a continuous system) can be in the range of 0.25-24 hr, 0.5-12 hr, or 1-6 hr.

The oxyalkylation catalysts useful according to the disclosure are not particularly limited and can generally include base catalysts (e.g., strong bases or super bases), for example those known for use in transesterification reactions. Examples include 1,8-diazabicyclo[5.4.0]undec-7-ene (DBU), 1,5,7-Triazabicyclo[4.4.0]dec-5-ene, 1,4-diazabicyclo[2.2.2]octane (DABCO), potassium tert-butoxide, tetra-n-butylammonium bromide (TBAB) (phase transfer catalyst), potassium carbonate, pyridine, and triethylene amine.

In embodiments, the oxyalkylation catalyst is added to or otherwise present in the reaction mixture in an amount in a range of 0.01 eq to 0.2 eq relative to the lignin hydroxyl content. For example, the oxyalkylation catalyst can be added to or otherwise present in the reaction mixture in an amount of at least 0.01, 0.02, 0.03, 0.04, or 0.05 eq and/or up to 0.06, 0.08, 0.1, 0.15, or 0.2 eq relative to the lignin hydroxyl content. When it is desired to subsequently use the oxyalkylated lignin polyol to form a rigid polyurethane foam in a subsequent step, the oxyalkylation catalyst can be present in the reaction mixture in an amount in a range of 0.03-0.08, 0.04-0.06, or about 0.05 eq relative to the lignin hydroxyl content to provide a suitable balance of viscosity and hydroxyl content. The molar equivalent “eq” unit represents in this case moles of oxyalkylation catalyst molecules or moles of total hydroxyl (—OH) groups initially in the lignin, which represents the sum of phenolic/aromatic hydroxyl, aliphatic hydroxyl groups, and carboxylic acid hydroxyl groups initially in the lignin.

In embodiments, the oxyalkylation catalyst is added to or otherwise present in the reaction mixture in an amount in a range of 0.01 eq to 0.08 eq relative to the lignin phenolic hydroxyl content. For example, the oxyalkylation catalyst can be added to or otherwise present in the reaction mixture in an amount of at least 0.01, 0.02, 0.025, or 0.03 eq and/or up to 0.05, 0.06, or 0.08 eq relative to the lignin phenolic hydroxyl content. Such values can be suitable to provide a suitable balance of viscosity and hydroxyl content when is desired to subsequently use the oxyalkylated lignin polyol to form a flexible polyurethane foam, polyurethane elastomer, or polyurethane adhesive in a subsequent step. The molar equivalent “eq” unit represents in this case moles of oxyalkylation catalyst molecules or moles of total phenolic hydroxyl (—OH) groups initially in the lignin, which represents the sum of phenolic/aromatic hydroxyl groups initially in the lignin.

Oxyalkylation of the lignin in the reaction mixture after catalyst addition can be performed using any suitable heating process. The oxyalkylation reaction can be performed at an elevated temperature (e.g., above 100° C.) to improve the rate and yield of the transesterification reaction, thereby improving the conversion of aromatic hydroxyl groups and to aliphatic hydroxyl groups in the oxyalkylated lignin polyol reaction product. Suitable reaction temperatures for the oxyalkylation reaction can be in the range of at least 100, 110, 120, 130, or 140° C. and/or up to 120, 140, 150, 160, 170, 180, or 200° C. Suitable reaction times (or residence times in a continuous system) can be in the range of 0.25-24 hr, 0.5-12 hr, or 1-6 hr, for example about 3 hr.

In embodiments, the oxyalkylation reaction can be performed in a sealed reaction vessel or pressure vessel, typically at a pressure above ambient or environmental pressure to prevent any inflow of air from the external environment. Performing the reaction in a sealed reaction vessel limits or prevents the loss of cyclic alkyl carbonate reactant during the reaction, thus improving conversion and yield for a given amount of added cyclic alkyl carbonate. Although the reaction temperature is generally below the boiling point of the cyclic alkyl carbonate (e.g., about 242° C. for propylene carbonate), the reaction temperature and corresponding vapor pressure of the cyclic alkyl carbonate is high enough to result in some vaporization and loss of the reactant in a reaction vessel open to the environment. Suitable reaction pressures can be in a range of 0.03-1 bar (about 0.5-15 psi), for example at least 0.03, 0.06, 0.1, 0.2, or 0.3 bar and/or up to 0.3, 0.5, 0.7, or 1 bar above ambient or environmental pressure (or a gauge pressure). The internal gaseous headspace in the reactor above the liquid reaction medium is suitably any inert or non-oxygen-containing gas such as nitrogen gas.

In embodiments, carbon dioxide produced during the oxyalkylation reaction can be vented from the sealed reaction vessel. Carbon dioxide is a byproduct of the oxyalkylation reaction as shown in Schemes 1 and 2. Accumulation of carbon dioxide in the reaction system is undesirable, because it can create excessive pressures in the reaction vessel as well as increased concentrations of carbon dioxide in the liquid reaction medium. Carbon dioxide in the liquid reaction medium can neutralize and deactivate base catalyst compounds such as DBU serving as the oxyalkylation catalyst, thus limiting overall conversion. Thus in some embodiments, it can be desirable to periodically vent accumulated carbon dioxide in the reaction vessel headspace to reduce the overall carbon dioxide in the reaction system. After venting, the reaction system is returned to a closed or sealed state while the reaction continues, thus limiting possible loss of the cyclic alkyl carbonate during the reaction.

In embodiments, additional cyclic alkyl carbonate and/or additional oxyalkylation catalyst can be added to the reaction mixture while performing the oxyalkylation reaction. The oxyalkylation catalyst can become ineffective during the course of an oxyalkylation reaction due to accumulation of carbon dioxide and catalyst deactivation, even with venting to remove carbon dioxide. In such cases, additional amounts of cyclic alkyl carbonate and fresh oxyalkylation catalyst can be added to the reaction vessel after starting the reaction with the initial cyclic alkyl carbonate and oxyalkylation catalyst. For example, evolution of carbon dioxide during the reaction can be monitored as an indicator of rate of reaction; when the rate of reaction drops significantly or stops, the additional cyclic alkyl carbonate and fresh oxyalkylation catalyst can be added to resume the reaction. Addition of the cyclic alkyl carbonate in separate aliquots in this manner also maintains a relatively lower excess of the carbonate, which in turn promotes reaction with the lignin instead of carbonate-carbonate self-polymerization.

The disclosed method can provide an oxyalkylated lignin polyol reaction product having an aliphatic hydroxy content, overall hydroxy value, and/or viscosity that can be selected within a relatively wide range depending on a desired end use for the oxyalkylated lignin polyol. For example, oxyalkylated lignin polyols having relatively high aliphatic hydroxy contents (e.g., about 3 to 6 mmol/g) are particularly suitable for forming rigid polyurethane foams, because the high aliphatic hydroxy content provides many isocyanate-reactive sites that can in turn provide a high crosslinking density in a corresponding polyurethane polymer. Similarly, oxyalkylated lignin polyols having relatively low aliphatic hydroxy contents (e.g., about 0.5 to 2 mmol/g) are particularly suitable for forming flexible polyurethane foams or elastomers, because the low aliphatic hydroxy content provides sufficient isocyanate-reactive sites for polymerization, but not so many that would result in a highly crosslinked polyurethane polymer.

In embodiments, the oxyalkylated lignin polyol reaction product can have an aliphatic hydroxy content in a range of 0.2 mmol/g to 6 mmol/g. For example, the oxyalkylated lignin polyol can have an aliphatic hydroxy content of at least 0.2, 0.3, 0.5, 0.6, 0.8, 1, 1.2, 1.5, 1.7, 2, 2.5, 3, 3.5, or 4 mmol/g and/or up to 0.7, 1, 1.2, 1.5, 1.8, 2, 2.5, 3, 3.5, 4, 4.5, 5, 5.5, or 6 mmol/g. Alternatively or additionally, the oxyalkylated lignin polyol reaction product can have a hydroxy value in a range of 20 to 400 mg KOH/g, 20 to 500 mg KOH/g, 20 to 800 mg KOH/g, or 40 to 200 mg KOH/g. For example, the oxyalkylated lignin polyol can have a hydroxy value of at least 20, 30, 40, 60, 80, 100, 120, 150, 200, 250, 300, or 350 mg KOH/g and/or up to 50, 75, 100, 150, 200, 300, 400, 500, 600, 700, or 800 mg KOH/g. Alternatively or additionally, the oxyalkylated lignin polyol reaction product can be a liquid at ambient temperatures (e.g., at 20-30° C.) and have a viscosity at 25° C. and shear rate of 50 s⁻¹ or 1000 s⁻¹ (1000 μm gap) in a range of 5 to 2000000 cP. For example, the oxyalkylated lignin polyol can have a viscosity at 25° C. and shear rate of 1000 s⁻¹ (1000 μm gap) of at least 5, 10, 20, 50, 100, 200, 500, 1000, 2000, 5000, or 10000 cP and/or up to 1500, 3000, 5000, 10000, 20000, 50000, 100000, 200000, 500000, 10000000, or 2000000 cP.

The oxyalkylation reaction can convert essentially all aromatic hydroxy and carboxylic acid groups in the original lignin to aliphatic hydroxy groups. For example, the oxyalkylated lignin polyol reaction product can be free or substantially free of aromatic hydroxy groups and/or carboxylic acid groups, such as having 0.001, 0.01, or 0.1 mmol/g or less aromatic hydroxy groups and/or carboxylic acid groups. Typically at least some of the original aliphatic hydroxy groups in the lignin also react via the oxyalkylation reaction such that the aliphatic hydroxy content in the oxyalkylated lignin polyol reaction product includes at least the oxyalkylated aliphatic hydroxy groups, but possibly also some remaining unreacted original aliphatic hydroxy groups in the lignin. The total number of hydroxy groups (e.g., aromatic, carboxylic, and aliphatic hydroxy groups combined) in a given molecule is generally conserved during the oxyalkylation reaction, but the overall molecular weight is generally increased with the addition of oxyalkyl groups, thus resulting in a lower total hydroxy group content on a per mass basis between the original lignin and the final oxyalkylated lignin polyol.

### Polyol-Based Polymers

The oxyalkylated lignin polyol according to the disclosure can be used to form any of a variety of polyol-based polymers according to methods generally known in the art. Namely, the polyhydroxy functionality of the oxyalkylated lignin polyol is useful as a first comonomer to react with a hydroxy-reactive second comonomer to form a corresponding polymer or copolymer, for example a thermoplastic, networked, crosslinked, or thermoset (co) polymers. Common examples include polyurethanes and polyesters, which can be formed by reacting the oxyalkylated lignin polyol with an isocyanate (or polyisocyanate) or an organic acid (or polyacid), respectively.

For example, an isocyanate (e.g., diisocyanate) can be added to the oxyalkylated lignin polyol reaction product, and the isocyanate/polyol mixture can be reacted to form a polyurethane polymer. An advantage of the disclosed process is that oxyalkylated lignin polyol as originally formed is suitable for further reaction to form a corresponding polyurethane directly in the same reaction vessel used for both water removal and oxyalkylation (e.g., as a one-pot synthesis starting from wet lignin). The polyurethane can be a highly crosslinked thermoset, a lightly or non-crosslinked polymer, elastomer, etc. depending on the hydroxy content of the oxyalkylated lignin polyol and the functionality of the isocyanate. Typically, the base catalysts that are suitable as oxyalkylation catalysts also catalyze the reaction between the oxyalkylated lignin polyol and the isocyanates, so any residual catalyst remaining after oxyalkylation is generally sufficient for polyurethane formation. In some cases, due to the generally higher rate of reaction for the polyurethane formation, it can be desirable to neutralize some of the residual catalyst remaining after oxyalkylation (i.e., lowering the amount of active catalyst but retaining at least some active catalyst).

The isocyanate is not particularly limited and generally can include any aromatic, alicyclic, and/or aliphatic monomeric, oligomeric, and/or polymeric isocyanates having at least two reactive isocyanate groups (—NCO) (e.g., di- or higher poly-functional isocyanates). Suitable isocyanates contain on average 2-4 isocyanate groups. In some embodiments, the isocyanate includes a diisocyanate. In some embodiments, the isocyanate includes triisocyanate. Suitable diisocyanates can have the general structure (O═C═N)—R—(N═C═O), where R can include aromatic, alicyclic, and/or aliphatic groups, for example having at least 2, 4, 6, 8, 10 or 12 and/or up to 8, 12, 16, or 20 carbon atoms. Examples of specific isocyanates include 1,5-naphthylene diisocyanate, 4,4′-diphenylmethane diisocyanate (MDI), hydrogenated MDI, polymeric methylene diphenyl diisocyanate (pMDI), xylene diisocyanate (XDI), tetramethylxylol diisocyanate (TMXDI), 4,4′-diphenyl-dimethylmethane diisocyanate, di- and tetraalkyl-diphenylmethane diisocyanate, 4,4′-dibenzyl diiso-cyanate, 1,3-phenylene diisocyanate, 1,4-phenylene diisocyanate, one or more isomers of tolylene diisocyanate (TDI, such as toluene 2,4-diisocyanate), 1-methyl-2,4-diiso-cyanatocyclohexane, 1,6-diisocyanato-2,2,4-trimethyl-hexane, 1,6-diisocyanato-2,4,4-trimethylhexane, 1-iso-cyanatomethyl-3-isocyanato-1,5,5-trimethylcyclohexane, chlorinated and brominated diisocyanates, phosphorus-containing diisocyanates, 4,4′-diisocyanatophenyl-perfluoroethane, tetramethoxybutane 1,4-diisocyanate, butane 1,4-diisocyanate, hexane 1,6-diisocyanate (or hexamethylene diisocyanate; HDI), HDI dimer (HDID), HDI trimer (HDIT), HDI biuret, dicyclohexylmethane diisocyanate, cyclohexane 1,4-diisocyanate, ethylene diisocyanate, phthalic acid bisisocyanatoethyl ester, 1-chloromethylphenyl 2,4-diisocyanate, 1-bromomethylphenyl 2,6-diisocyanate, 3,3-bischloromethyl ether 4,4′-diphenyldiisocyanate, trimethylhexamethylene diisocyanate, 1,4-diisocyanato-butane, 1,2-diisocyanatododecane, and combinations thereof. The isocyanate can be biobased or made of synthetic feedstock. Examples of suitable biobased isocyanates include pentamethylene diisocyanate trimer, and isocyanates formed from base compounds to which isocyanate groups are attached (e.g., via suitable derivatization techniques), including isocyanate-terminated poly(lactic acid) having two or more isocyanate groups, isocyanate-terminated poly(hydroxyalkanaotes) having two or more isocyanate groups, isocyanate-terminated biobased polyesters having two or more isocyanate groups.

Similarly, an organic acid with carboxylic acid/carboxylate functionality (e.g., diacid) can be added to the oxyalkylated lignin polyol reaction product, and the acid/polyol mixture can be reacted to form a polyester polymer. This is analogous to the polyurethane formation as described above, but using an organic di- or higher-functional acid to form a corresponding polyester. Examples of suitable organic acids include alkyl and/or aryl acids such as terephthalic acid, maleic acid, and fumaric acid.

### EXAMPLES

The following examples illustrate the disclosed compositions and methods, but are not intended to limit the scope of any claims thereto.

### Example 1: Synthesis of High Hydroxyl Value Polyol

This example illustrates methods according to the disclosure for forming high hydroxyl value oxyalkylated lignin polyols (e.g., target OH value: 200-380 mg KOH/g) particularly suitable for rigid foams, coatings, and adhesives applications. The type of lignin used was hardwood/hydrolysis with total hydroxyl content of 5.43 mmol/g.

Method 1: This method used polyethylene glycol 400 as polyol reactive solvent and 1,8-diazabicyclo[5.4.0]undec-7-ene as catalyst). The type of lignin used was hardwood/hydrolysis with total hydroxyl content of 5.43 mmol/g. Briefly, 100 g oven dried lignin is mixed with 110.9 g propylene carbonate (PC) (2 equivalent molar ratio of total hydroxyl content of lignin) in a Parr reactor. 122.5 g of PEG 400 is then added to lignin-PC mixture to obtain 30% lignin content in total reaction mixture. 1,8-Diazabicyclo[5.4.0]undec-7-ene is added to the reaction mixture based on the target application: For rigid foams, 4.13 g 1,8-Diazabicyclo[5.4.0]undec-7-ene (0.05 molar equivalent of total hydroxyl content of lignin) is added to the mixture. For adhesives: 0.945-1.89 g 1,8-diazabicyclo[5.4.0] undec-7-ene (0.025-0.05 molar equivalent of total phenolic content of lignin) is added to the mixture. Low catalyst content is desired to increase gel time to ensure easy application of adhesive on substrate (wood). The reactor is purged with nitrogen gas for 5 min to completely remove air trapped in the reactor. The pressure of the reactor is adjusted to 1 atm (this low pressure avoids entering air). The mixture is heated at 150° C. for 0.5-2.5 hours for the reaction to take place. Gas outlet valve is opened occasionally to vent carbon dioxide produced from the reaction to avoid pressure build-up in the reactor. At the end of the reaction, the heater is turned off and the reaction mixture is allowed to cool to room temperature.

Method 2: This method used polyethylene glycol 400 as polyol reactive solvent and 1,5,7-triazabicyclo[4.4.0]dec-5-ene as catalyst). The type of lignin used was hardwood/hydrolysis with total hydroxyl content of 5.43 mmol/g. Briefly, 100 g oven dried lignin is mixed with 110.9 g propylene carbonate (PC) (2 equivalent molar ratio of total hydroxyl content of lignin) in a Parr reactor. 122.5 g of PEG 400 is then added to lignin-PC mixture to obtain 30% lignin content in total reaction mixture. 1,5,7-Triazabicyclo[4.4.0]dec-5-ene is added to the reaction mixture based on the target application: For rigid foams, 3.78 g of 1,5,7-Triazabicyclo[4.4.0]dec-5-ene (0.05 molar equivalent of total hydroxyl content of lignin) is added to the mixture. For adhesives, 0.87-1.73 g 1,5,7-Triazabicyclo [4.4.0]dec-5-ene (0.025-0.05 molar equivalent of total phenolic content of lignin) is added to the mixture. Low catalyst content is desired to increase gel time to ensure easy application of adhesive on substrate. The reactor is purged with nitrogen for 5 min to completely remove air trapped in the reactor. The pressure of the reactor is adjusted to 1 atm (this low pressure avoids entering air). The mixture is heated at 150° C. for 0.5-2.5 hours for the reaction to take place. Gas outlet valve is opened occasionally to vent carbon dioxide produced from the reaction to avoid pressure build-up in the reactor. At the end of the reaction, the heater is turned off and the reaction mixture is allowed to cool to room temperature.

Method 3: This method used polyethylene glycol 200 as polyol reactive solvent and 1,8-diazabicyclo[5.4.0]undec-7-ene as catalyst). The type of lignin used was hardwood/hydrolysis with total hydroxyl content of 5.43 mmol/g. Briefly, 100 g oven dried lignin is mixed with 110.9 g propylene carbonate (PC) (2 equivalent molar ratio of total hydroxyl content of lignin) in a Parr reactor. 122.5 g of PEG 200 is then added to lignin-PC mixture to obtain 30% lignin content in total reaction mixture. 1,8-Diazabicyclo[5.4.0]undec-7-ene is added to the reaction mixture based on the target application: For rigid foams, 4.13 g 1,8-Diazabicyclo[5.4.0]undec-7-ene (0.05 molar equivalent of total hydroxyl content of lignin) is added to the mixture. For adhesives, 0.945-1.89 g 1,8-Diazabicyclo[5.4.0] undec-7-ene (0.025-0.05 molar equivalent of total phenolic content of lignin) is added to the mixture. Low catalyst content is desired to increase gel time to ensure easy application of adhesive on substrate (wood). The reactor is purged with nitrogen gas for 5 min to completely remove air trapped in the reactor. The pressure of the reactor is adjusted to 1 atm (this low pressure avoids entering air). The mixture is heated at 150° C. for 0.5-2.5 hours for the reaction to take place. Gas outlet valve must be opened occasionally to vent carbon dioxide produced from the reaction to avoid pressure build-up in the reactor. At the end of the reaction, the heater is turned off and the reaction mixture is allowed to cool to room temperature.

### Example 2: Synthesis of Low Hydroxyl Value Polyol

This example illustrates methods according to the disclosure for forming low hydroxyl value oxyalkylated lignin polyols (e.g., target OH value: up to 150 mg KOH/g) particularly suitable for flexible foams and elastomers applications. The type of lignin used was hardwood/hydrolysis with total hydroxyl content of 5.43 mmol/g.

Method 1: This method used polyethylene glycol 1000 as polyol reactive solvent and 1,8-diazabicyclo[5.4.0]undec-7-ene as catalyst). The type of lignin used was hardwood/hydrolysis with total hydroxyl content of 5.43 mmol/g. Briefly, 100 g oven dried lignin is mixed with 110.9 g propylene carbonate (PC) (2 equivalent molar ratio of total hydroxyl content of lignin) in a Parr reactor. 122.5 g of PEG 1000 is then added to lignin-PC mixture to obtain 30% lignin content in total reaction mixture. 1.89 g of 1,8-Diazabicyclo [5.4.0]undec-7-ene (0.05 molar equivalent of total phenolic hydroxyl content of lignin) is added to the mixture. The reactor is purged with nitrogen for 5 min to completely remove air trapped in the reactor. The pressure of the reactor is adjusted to 1 atm (this low pressure avoids entering air). The mixture is heated at 150° C. for 0.5-1.5 hours for the reaction to take place. Shorter reaction times are desired to partially convert phenolics to aliphatic hydroxyl groups to reduce crosslinking density when polyols are reacted with isocyanate for flexible foams and elastomers applications. Gas outlet valve must be opened occasionally to vent carbon dioxide produced from the reaction to avoid pressure build-up in the reactor. At the end of the reaction, the heater is turned off and the reaction mixture is allowed to cool to room temperature.

Method 2: This method used polyethylene glycol 1000 as polyol reactive solvent and 1,5,7-triazabicyclo[4.4.0]dec-5-ene as catalyst). The type of lignin used was hardwood/hydrolysis with total hydroxyl content of 5.43 mmol/g. Briefly, 100 g oven dried lignin is mixed with 110.9 g propylene carbonate (PC) (2 equivalent molar ratio of total hydroxyl content of lignin) in a Parr reactor. 122.5 g of PEG 1000 is then added to lignin-PC mixture to obtain 30% lignin content in total reaction mixture. 1.73 g of 1,5,7-Triazabicyclo [4.4.0]dec-5-ene (0.05 molar equivalent of total phenolic hydroxyl content of lignin) is added to the mixture. The reactor is purged with nitrogen for 5 min to completely remove air trapped in the reactor. The pressure of the reactor is adjusted to 1 atm (this low pressure avoids entering air). The mixture is heated at 150° C. for 0.5-1.5 hours for the reaction to take place. Shorter reaction times are desired to partially convert phenolics to aliphatic hydroxyl groups to reduce crosslinking density when polyols are reacted with isocyanate for flexible foams and elastomers applications. Gas outlet valve must be opened occasionally to vent carbon dioxide produced from the reaction to avoid pressure build-up in the reactor. At the end of the reaction, the heater is turned off and the reaction mixture is allowed to cool to room temperature.

Method 3: This method performed lignin-propylene carbonate oxyalkylation under reduced pressure. The type of lignin used was hardwood/hydrolysis with total hydroxyl content of 5.43 mmol/g. This modification method is for polyurethane elastomer formulation where low hydroxyl value polyol and additional solvent is used as a viscosity reducer. Excess propylene carbonate is used and the reaction is conducted in two stages: In Stage 1, the reaction fully converts phenolic and carboxylic hydroxyl groups to aliphatic hydroxyl groups at atmospheric pressure. In Stage 2, the transesterification reaction is performed under reduced pressure or complete vacuum to reduce OH value. By applying vacuum or negative/reduced pressure, the obtained product had a significantly low hydroxyl value lignin suitable for flexible foam and elastomer applications. Below, a detailed description of these stages is provided.

Stage 1 (at 1 atm): 100 g oven dried lignin is mixed with 221.76 g propylene carbonate (PC) (4 equivalent molar ratio of total hydroxyl content of lignin) in a Parr reactor. 4.13 g of 1,8-Diazabicyclo[5.4.0]undec-7-ene (0.05 molar equivalent of total hydroxyl content of lignin) is added to the mixture. The reactor is purged with nitrogen for 5 min to completely remove air trapped in the reactor. The pressure of the reactor is adjusted to 1 atm (this low pressure avoids entering air). The mixture is heated at 150° C. for 1.5 hours for the reaction to take place. Gas outlet valve is opened occasionally to vent carbon dioxide produced from the reaction to avoid pressure build-up in the reactor. At the end of the reaction, the heater is turned off and the reaction mixture is allowed to cool to a temperature of 50° C.

Step 2 (at reduced pressure): A distillation setup connected to a vacuum pump is used. After 1.5 hours of Stage 1, the mixture is transferred into the distilling flask. The pressure in the system is reduced to 0.1-0.3 atm or complete vacuum and the mixture is heated at 150° C. with constant mixing for additional 0.5-1 hour for the transesterification reaction to take up. Propylene glycol by-product produced is condensed in the receiving flask.

Method 4: This method used acetone-fractionated kraft lignin to produce lignin polyol with low viscosity and good solubility in co-polyols. The type of lignin was kraft/softwood with total hydroxyl content of 5.53 mmol/g. Briefly, 200 g of dried lignin is dissolved in 2000 ml of acetone. The mixture is stirred gently for 12 hours to ensure enough contact between lignin and acetone. The acetone-soluble part is filtered to remove small particles suspending in the solution. Acetone-soluble lignin (ASL), which possesses low molecular weights, low dispersity and high phenolic hydroxyl content, is obtained by evaporating acetone using a rotary evaporator. ASL represents about 70% by weight of kraft lignin. The hydroxyl value of ASL was 5.92 mmol/g. Acetone-insoluble lignin (AIL), which possesses high molecular weights, high dispersity and low phenolic hydroxyl content, is washed and dried. 100 g oven dried ASL lignin is mixed with 181.3 g propylene carbonate (PC) (3 equivalent molar ratio of total hydroxyl content of lignin) in a Parr reactor. 1.43 g of 1,8-Diazabicyclo[5.4.0]undec-7-ene (0.025 molar equivalent of total phenolic hydroxyl content of lignin) is added to the mixture. The reactor is purged with nitrogen for 5 min to completely remove air trapped in the reactor. The pressure of the reactor is adjusted to 1 atm (this low pressure avoids entering air). The mixture is heated at 150° C. for 0.5-3 hours for the reaction to take place. Gas outlet valve is opened occasionally to vent carbon dioxide produced from the reaction to avoid pressure build-up in the reactor. At the end of the reaction, the heater is turned off and the reaction mixture is allowed to cool to room temperature.

Method 5: This method used an additional extraction step to remove unreacted PC from lignin polyol using Castor oil. About 50 g of oxyalkylated lignin polyol containing about 60% unreacted PC was mixed with about 50 g of commercial-grade castor oil. The mixture was stirred at 2000 rpm for 5 minutes and allowed to settle for 72 hours (or the mixture was centrifuged at 4000 rpm at 25° C. for 20 mins. After 72 hours, a phase separation is observed, with castor oil at the top (containing unreacted propylene carbonate) and liquid lignin polyol at the bottom. The lignin polyol with a reduced amount of unreacted PC is separated from the mixture by decantation. The results showed that about 20% of unreacted PC was removed or separated from oxyalkylated lignin polyol with castor oil. Orgonosolv ligol (ligol 13) viscosity increased by four times after 20% unreacted PC removal. The precipitated modified lignin mixed well with castor oil. Table 1 below summarizes the properties for PC removal and viscosity, both before extraction (initial) and after extraction (final).

TABLE 1
Polycarbonate (PC) Removal from Oxyalkylated Lignin Polyol Using Cator Oil

| | Initial | Initial Amount | Final Viscosity | Final Amount | Removal of |
|---|---|---|---|---|---|
| | Viscosity cP | Unreacted PC | CP | Unreacted PC | Unreacted PC |
| Ligol | (25° C.) | (wt. %) | (25° C.) | (wt. %) | (wt. %) |
| Ligol 6 | 8300 | 68% | 12400 | 55% | 20% |
| (Kraft) | | | | | |
| Ligol 6 | 11000 | 64% | 43000 | 50% | 22% |
| (Organosolv) | | | | | |

### Example 3: Synthesis of Oxyalkylated Lignin Polyols and Polyurethanes

Oxyalkylated lignin polyols according to the disclosure and following the methods in Examples 1 and 2 above were formed using a variety of lignin types (source and isolation method). The reaction parameters were varied to provide oxyalkylated lignin polyols with different hydroxyl and viscosity values suitable for different polyurethane applications, such as flexible foams, elastomers, rigid foams, and adhesives. Selected oxyalkylated lignin polyols were further reacted with an isocyanate to form corresponding polyurethane flexible foams or polyurethane adhesives.

Tables 2-5 summarize the results for Example 3: Table 2 summarizes the lignin types and polyol properties for the oxyalkylated lignin polyols formed. Table 3 summarizes the reaction parameters for forming the oxyalkylated lignin polyols. Table 4 summarizes the properties of the polyurethane flexible foams formed. Table 5 summarizes the properties of the polyurethane adhesives formed.

TABLE 2
Lignin types and oxyalkylated lignin polyol properties

| | | | Polyol OH | Polyol Viscosity | |
|---|---|---|---|---|---|
| Polyol | Lignin | Lignin | Value (mg | (cP) at 25° | |
| ID | Isolation | Source | KOH/g) | C., 50 s⁻¹ | Note |
| 1 | Hydrolysis | Hardwood | 149 | 4844 ± 67 | Flexible Foam/ |
| | | | | | Elastomer |
| 2 | Hydrolysis | Hardwood | 145 | 8450 ± 109 | Flexible Foam/ |
| | | | | | Elastomer |
| 3 | Kraft | Softwood | 123 | 6200 ± 50 | Flexible Foam/ |
| | | | | | Elastomer |
| 4 | Kraft | Softwood | 109 | 8460 ± 114 | Flexible Foam/ |
| | | | | | Elastomer |
| 5 | Organosolv | Wheat straw | 119 | 8620 ± 190 | Flexible Foam/ |
| | | | | | Elastomer |
| 6 | Organosolv | Wheat straw | 109 | 10,720 ± 260 | Flexible Foam/ |
| | | | | | Elastomer |
| 7 | Hydrolysis | Hardwood | 266 | 7554 | Rigid foam |
| 8 | Hydrolysis | Hardwood | 277 | 13,534 | Rigid foam |
| 9 | Hydrolysis | Hardwood | 229 | 6678 ± 90 | Rigid foam |
| 10 | Hydrolysis | Hardwood | 365 | 4355 ± 56 | Rigid foam |
| 11 | Kraft | Softwood | 181 | 6260 ± 26 | Adhesive |
| 12 | Organosolv | Wheat straw | 211 | 2510 ± 60 | Adhesive |
| 13 | Kraft (ASL) | Softwood | 123 | 960 | Adhesive |
| 14 | Hydrolysis | Hardwood | 175 | 2583 | Stage 1 (1 atm) |
| 14 | Hydrolysis | Hardwood | 90 | 7358 | Stage 2 (vac.) |

Notes:
ASL = acetone-soluble lignin; Polyol 14 was formed by the two-stage process in Example 2/Method 3, and the polyol properties are reported for the intermediate polyol product (Stage 1) and the final polyol product (Stage 2).

TABLE 3
Reaction parameters for forming oxyalkylated lignin polyols

| | PC | | | | Catalyst | PEG | Ligin | PEG | PC |
|---|---|---|---|---|---|---|---|---|---|
| Polyol | Molar | Time | Temp. | | Molar | MW | Loading | Loading | Loading |
| ID | Ratio | (hr) | (° C.) | Catalyst | Ratio | (g/mol) | (wt. %) | (wt. %) | (wt. %) |
| 1 | 2 | 0.5 | 150 | DBU | 0.05 wrt | 1000 | 30 | 37 | 33 |
| | | | | | PhOH | | | | |
| 2 | 2 | 1 | 150 | DBU | 0.05 wrt | 1000 | 30 | 37 | 33 |
| | | | | | PhOH | | | | |
| 3 | 3 | 1 | 150 | DBU | 0.05 wrt | 1000 | 30 | 19.2 | 50.8 |
| | | | | | PhOH | | | | |
| 4 | 3 | 1.5 | 150 | DBU | 0.05 wrt | 1000 | 30 | 19.2 | 50.8 |
| | | | | | PhOH | | | | |
| 5 | 3 | 0.5 | 150 | DBU | 0.05 wrt | 1000 | 30 | 34 | 36 |
| | | | | | PhOH | | | | |
| 6 | 3 | 1 | 150 | DBU | 0.05 wrt | 1000 | 30 | 34 | 36 |
| | | | | | PhOH | | | | |
| 7 | 2 | 1.5 | 150 | DBU | 0.05 wrt | 400 | 30 | 37 | 33 |
| | | | | | Total OH | | | | |
| 8 | 2 | 2.5 | 150 | DBU | 0.05 wrt | 400 | 30 | 37 | 33 |
| | | | | | Total OH | | | | |
| 9 | 2 | 1 | 150 | TBD | 0.05 wrt | 400 | 30 | 37 | 33 |
| | | | | | Total OH | | | | |
| 10 | 2 | 1.5 | 150 | DBU | 0.05 wrt | 200 | 30 | 37 | 33 |
| | | | | | Total OH | | | | |
| 11 | 2 | 0.5 | 150 | DBU | 0.05 wrt | 400 | 30 | 36 | 34 |
| | | | | | PhOH | | | | |
| 12 | 2 | 0.5 | 150 | DBU | 0.05 wrt | 400 | 30 | 47 | 23 |
| | | | | | PhOH | | | | |
| 13 | 3 | 0.5 | 150 | DBU | 0.025 wrt | n/a | 36 | n/a | 64 |
| | | | | | PhOH | | | | |
| 14 | 4 | 1.5 (1 | 150 | DBU | 0.05 wrt | n/a | 31 | n/a | 69 |
| | | atm) | | | Total OH | | | | |
| 14 | | 1 (vac.) | 150 | | | | | | |

Notes:
PC = propylene carbonate; PEG = polyethylene glycol as reactive polyol co-solvent; DBU = 1,8-Diazabicyclo [5.4.0] undec-7-ene; TBD = 1,5,7-Triazabicyclo [4.4.0] dec-5-ene; wrt = with respect to; PhOH = lignin phenolic hydroxy groups; Total OH = lignin total hydroxy groups; loading = wt. % of component in reaction medium before reaction; Polyol 14 was formed by the two-stage process in Example 2/Method 3, and the reaction conditions are reported for Stage 1 (1 atm) and Stage 2 (vac.).

TABLE 4
Properties of polyurethane (PU) flexible foams

| Poly- | | | | Tensile | | Tear |
|---|---|---|---|---|---|---|
| ol | Density | CFD | | Strength | Elongation | Strength |
| ID | (kg/m³) | (kPa) | Support | (kPa) | (%) | (N/m) |
| Con- | 40 ± 1 | 4 ± 0 | 3 ± 0 | 64 ± 10 | 83 ± 13 | 116 ± 8 |
| trol | | | | | | |
| 6 | 41 ± 3 | 8 ± 1 | 3 ± 0 | 77 ± 7 | 53 ± 3 | 136 ± 15 |
| 1 | 40 ± 0.4 | 6 ± 0.5 | 3 ± 0.3 | 78 ± 5.6 | 67 ± 3.0 | 113 ± 13 |
| 2 | 35 ± 1.4 | 6 ± 0.8 | 3 ± 0.2 | 85 ± 14 | 55 ± 4.9 | 132 ± 21 |

Notes:
Polyol ID is from Tables 2-3 (rigid/adhesive polyols); Foams were tested according to ASTM D3574 standard.

The control polyol was a commercially available polyether polyol. The PU foams were formed with the control polyol alone (control; no lignin content) or with an 80/20 blend of the control polyol and the indicated oxyalkylated lignin polyol using an isocyanate index (NCO/OH) of 1.

Compression Force Deflection (CFD) is the stress needed to compress foam to 50% strain. Support factor is the ratio of stress at 65% to stress at 25% strain.

TABLE 5
Properties of polyurethane (PU) adhesives

| | Dry Adhesive | Wet Adhesive |
|---|---|---|
| | Strength | Strength |
| Polyol ID | (A1) (MPa) | (A4) (MPa) |
| 11 | 8.56 ± 1.08 | 6.7 ± 0.92 |
| 12 | 9.5 ± 0.9 | 6.98 ± 1.02 |
| Commercial 2K | 8.5 ± 0.3 | 5.2 ± 0.75 |
| Commercial 1K | 9.2 ± 0.67 | 6.1 ± 0.6 |

Notes:
Polyol ID is from Tables 2-3 (rigid/adhesive polyols); Foams were tested according EN-302-2013 standard.

The PU adhesives according to the disclosure included the oxyalkylated lignin polyol as the only polyol, using an isocyanate index (NCO/OH) of 2. Commercial 1K and Commercial 2K were comparative commercially available PU adhesive compositions.

The assessment of dry and wet adhesive properties is conducted in accordance with the European standard EN 302-1:2013. To evaluate dry adhesive strength, designated as A1 in the standard, the samples are tested immediately at 25° C. and RH 65±2% after curing without exposure to any moisture conditions. In contrast, the wet adhesive strength, labeled A4 in the standard, is determined by subjecting the samples to a rigorous wetting process. This involves immersing the samples in boiling water for four hours, followed by a two-hour submersion in cold water at a temperature of 25° C., and testing the adhesion strength of samples immediately after cold water immersion.

As illustrated in Tables 2 and 3, the inclusion of a polyol reactive co-solvent (e.g., PEG) helped to reduce the amount of cyclic alkyl carbonate (e.g., propylene carbonate (PC)), which in turn allowed the formation of oxyalkylated lignin polyols at substantially lower lignin: cyclic alkyl carbonate ratios (e.g., about 1:2 to 1:3 w/w) relative to typical methods in WO 2022/192615 (about 1:10 w/w), while still providing oxyalkylated lignin polyols with suitable viscosity values (e.g., about 10,000 cP or less at 25° C.) and hydroxyl values (e.g., broadly selectable between about 20 to 800 mg KOH/g or 80 to 500 mg KOH/g depending on end use) for subsequent use to form a polyurethane.

### Example 4: Synthesis of Low Hydroxyl Value Polycarbonate Polyol

This example illustrates methods according to the disclosure for forming low hydroxyl value oxyalkylated lignin polyols (e.g., target OH value: up to 150 mg KOH/g) particularly suitable for flexible foams, elastomers, and coatings applications.

Method 1: This method used polyethylene glycol as polyol reactive solvent and dimethyl carbonate as transesterification agent. The type of lignin used was hardwood/hydrolysis with total hydroxyl content of 5.43 mmol/g. A two-step transesterification process was used:

Step 1—Oxyalkylation in the presence of cyclic carbonates: 100 g oven-dried lignin is mixed with 110.9 g propylene carbonate (PC) (2 equivalent molar ratios of total hydroxyl content of lignin) in a Parr reactor. 122.5 g of polyethylene glycol is then added to the lignin-PC mixture to obtain 30% lignin content in the total reaction mixture. Polyethylene glycol of any molecular weight (200, 300, 400, 600, and 1000) can be used depending on the target application. Biobased PEG can also be used. 4.133 g of 1,8-Diazabicyclo[5.4.0] undec-7-ene (0.05 molar equivalent of total hydroxyl content of lignin) is added to the mixture. Potassium carbonate and 1,5,7-Triazabicyclo[4.4.0]dec-5-ene are alternative catalyst that can be employed in-place of 1,8-Diazabicyclo[5.4.0]undec-7-ene. The reactor is purged with nitrogen for 5 min to remove air trapped in the reactor. The mixture is heated at 150° C. at atmospheric pressure for 0.5-1.5 hours for the reaction to take place. Shorter reaction times are desired for reactions catalyzed by potassium carbonate to avoid potential lignin-lignin transesterification side reactions. The gas outlet valve is opened occasionally to vent carbon dioxide produced from the reaction to avoid pressure build-up in the reactor. At the end of the reaction, the heater is turned off, and the reaction mixture is allowed to cool to room temperature for the transesterification step. The total hydroxyl value (mmol/g) of the final reaction product was measured.

Step 2—Transesterification in the presence of dimethyl carbonate (DMC). 100 g of the reaction mixture in step 1 is weighed in a three-neck flask, and 29.30 g of dimethyl carbonate (0.5 eq. with respect to total hydroxy value in mmol/g of step 1 product) is added. Diethyl carbonate (DEC) can be employed in place of DMC. A linear carbonate ratio can be varied based on the target polyol property. 0.5, 0.75 and 0.85 eq. ratio of DMC can be used in this step. The mixture is heated at 150° C. under reflux, with continuous stirring, for 30 minutes. Lower temperatures such as 85, 120, 130, and 140° C. can be used; however, this will require higher reaction time to achieve similar results. At the end of the reaction, methanol or ethanol (byproduct, depending on which linear carbonate was used) and unreacted linear carbonate are distilled from the reaction mixture at 90° C. under vacuum for about 10 minutes.

Tables 6 and 7 below summarize the properties for oxyalkylated lignin polyol properties and mechanical properties of a flexible polyurethane foam formed from the oxyalkylated lignin polyol.

TABLE 6
Polyol properties based on the molecular
weight of polyethylene glycol used

| Polyol | PEG | Hydroxyl Value | Viscosity |
|---|---|---|---|
| ID | Mn | (mgKOH/g) | (cP) |
| 1 | 200 | 180 | 11,660 ± 450 |
| 2 | 400 | 151 | 16,880 ± 750 |
| 3 | 600 | 111 | 25,950 ± 930 |

TABLE 7
Mechanical properties of lignin polyol-based (30% polyol substitution)
flexible polyurethane foam according to ASTM D3574 standards

| Mechanical | Desired | | Measured |
|---|---|---|---|
| Property | range | Unit | values |
| Density | 40-65 | kg/m³ | 47 ± 0.4 |
| Tear strength | 100 | N/m | 112 ± 9 |
| Compression Force | 3-12 | kPa | 8 ± 0.4 |
| Deflection (CFD) | | | |
| Sag factor | — | — | 4 ± 0.2 |
| Tensile strength | 50 | kPa | 89 ± 8.7 |
| Elongation | 60 | % strain | 45 ± 4.6 |
| Hysteresis loss | — | % | 53 ± 1.0 |

Notes:
The PU foam was formed with a 70/30 blend of a commercially available polyether polyol and the oxyalkylated lignin polyol 2 from Table 6 using an isocyanate index (NCO/OH) of 1.

### Example 5: Synthesis of low hydroxyl value polyol

This example illustrates methods according to the disclosure for forming low hydroxyl value oxyalkylated lignin polyols (e.g., target OH value: up to 100 mg KOH/g) particularly suitable for adhesive applications.

Method 1: This method used polyethylene glycol as polyol reactive solvent and dimethyl carbonate to form carbonate-functionalized polyol derivative, followed by transesterification with lignin. The type of lignin used was wheat straw/organosolv with total hydroxyl content of 3.9 mmol/g. A two-step process was used:

Step 1—Formation of carbonate-terminated PEG: 100 g of polyethylene glycol (MW 400 Da) is weighed in a three-neck flask, and 90.08 g of dimethyl carbonate (2 eq. with respect to total hydroxy value in mmol/g of PEG) is added. Diethyl carbonate (DEC) can be employed in place of DMC. 3.48 g of 1,5,7-Triazabicyclo[4.4.0]dec-5-ene (0.05 molar equivalent of total hydroxyl content of PEG) is added to the mixture. The mixture is heated at 85° C. under reflux, with continuous stirring, for 2 hours. At the end of the reaction, methanol or ethanol (byproduct, depending on which linear carbonate was used) and unreacted linear carbonate are distilled from the reaction mixture at 90° C. under a vacuum for about 10 minutes.

Step 2—Transesterification with lignin: 30 g of oven-dried lignin is dissolved in 70 g of carbonate-terminated PEG, produced in step 1, in a three-necked flask equipped with a short-path condenser. The mixture is heated at 150° C. with continuous stirring for 1 hour under a vacuum, and produced methanol is collected.

Tables 8 and 9 below summarize the properties for the carbonate-terminated PEG and the oxyalkylated lignin polyol formed in this example.

TABLE 8
Properties of carbonate terminated PEG
at different reaction times (step 1)

| | | | | Hydroxyl | Viscosity |
|---|---|---|---|---|---|
| Time | | | | conversion | (cP) at |
| (h) | Mn | MW | PDI | (p) | 25° C. |
| 2 | 1175 | 2112 | 1.80 | 0.936 | 538 |
| 4 | 1283 | 2463 | 1.92 | 0.982 | 825 |

TABLE 9
Properties of polyol after transesterification with lignin (step 2)

| | Reaction | Hydroxyl | Viscosity |
|---|---|---|---|
| | time | Value | (cP) at |
| Polyol ID | (h) | (mgKOH/g | 25° C. |
| 1 | 1 | 98 | 11,000 |

### Example 6: Synthesis of High Hydroxyl Value Polyol

This example illustrates methods according to the disclosure for forming high hydroxyl value oxyalkylated lignin polyols (e.g., target OH value: 370-700 mg KOH/g) particularly suitable for rigid foam applications.

Method 1: This method involved reacting excess cyclic alkyl carbonate with lignin, followed by ring-opening reaction with water. The type of lignin used was hardwood/hydrolysis with total hydroxyl content of 5.43 mmol/g. A two-step process was used.

Step 1—Oxyalkylation: 100 g oven-dried lignin is mixed with 221.76 g propylene carbonate (PC) (4 equivalent molar ratios of total hydroxyl content of lignin) in a Parr reactor. 2.07 g of 1,8-Diazabicyclo[5.4.0] under-7-ene (0.025 molar equivalents of total hydroxyl content of lignin) is added to the mixture. The reactor is purged with nitrogen for 5 min to completely remove air trapped in the reactor. The pressure of the reactor is adjusted to 1 atm (this low pressure prevents air from entering the reactor). The mixture is heated at 150° C. for 3 hours for the reaction to proceed. 0.05 eq. ratio of catalyst will require about 1.5 hours of reaction to achieve a similar polyol property. Gas outlet valve is opened occasionally to vent carbon dioxide produced from the reaction to prevent pressure build-up in the reactor. At the end of the reaction, the heater is turned off, and the reaction mixture is allowed to cool to a temperature of 50° C.

Step 2—Water-cyclic carbonate ring-opening reaction: 100 g of the reaction mixture in step 1 is weighed in a three-neck flask, and 2.86 g of water is added. The amount of water added was calculated based on the desired hydroxyl value, assuming that propylene carbonate consumes all the water added to produce propylene glycol. The mixture is heated at 150° C. under reflux, with continuous stirring, for 30 minutes. Lower temperatures such as 90, 100, 110, 120, 130, and 140° C. can be used; however, these will require longer reaction times to achieve similar results. At the end of the reaction, unreacted water is removed from the reaction mixture at 90° C. for about 10 minutes under vacuum. The final reaction product, containing both modified lignin, oligomeric glycols, and unreacted propylene carbonate, is used directly in rigid foam formulation.

Tables 10 and 11 below summarize the properties for the oxyalkylated lignin polyol and rigid foam formed using the oxyalkylated lignin polyol in this example.

TABLE 10
Polyol properties based on amount of water added

| | Mass of water | | |
|---|---|---|---|
| | added per 100 g | Hydroxyl | Viscosity |
| | of step 1 mixture | Value | (cP) at |
| Polyol ID | (g) | (mgKOH/g | 25° C. |
| 1 | 2.86 | 379 | 1781 ± 11 |
| 2* | 2.86 | 425 | 3921 ± 63 |
| 3 | 3.62 | 472 | 3249 ± 29 |

*For Polyol 2, 0.05 eq. DBU catalyst was used.

TABLE 11
Rigid foam properties (100% polyol replacement)

| Foam | Desired | | Measured |
|---|---|---|---|
| Property | range | Unit | values |
| Density | — | kg/cu m | 46.65 ± 0.91 |
| Compressive strength | 173 | kPa | 297.52 ± 9.07 |
| Thermal conductivity | 0.0229 | W/mK | 0.0327 ± 0.012 |
| Closed cell content | ≥90 | % | 92.33 ± 0.23 |

Notes:
The PU foam was formed with the oxyalkylated lignin polyol 1 from Table 10 using an isocyanate index (NCO/OH) of 1.2.

Method 2: This method involved using glycerol as a polyol reactive solvent and 1,8-Diazabicyclo[5.4.0]undec-7-ene as catalyst. The type of lignin used was hardwood/hydrolysis with total hydroxyl content of 4.52 mmol/g. Briefly, 100 g oven-dried lignin is mixed with 138.4 g propylene carbonate (PC) 3 equivalent molar ratio of total hydroxyl content of lignin) in a Parr reactor. 94 g of glycerol is then added to lignin-PC mixture to obtain 30% lignin content in total reaction mixture. 3.44 g 1,8-Diazabicyclo[5.4.0] undec-7-ene (0.05 eq. with respect to total hydroxyl content of lignin) is added to the reaction mixture based on the target application. The reactor is purged with nitrogen gas for 5 min to completely remove air trapped in the reactor. The pressure of the reactor is adjusted to 1 atm (this low pressure avoids entering air). The mixture is heated at 150° C. for 0.5-3 hours for the reaction to take place. Gas outlet valve must be opened occasionally to vent carbon dioxide produced from the reaction to avoid pressure build-up in the reactor. At the end of the reaction, the heater is turned off, and the reaction mixture is allowed to cool to room temperature.

Table 12 below summarizes the properties for the oxyalkylated lignin polyol formed in this example.

TABLE 12
Polyol properties

| | Lignin | Hydroxyl | Viscosity |
|---|---|---|---|
| | Loading | Value | (cP) at |
| Polyol ID | (%) | (mg KOH/g) | 50° C. |
| 1 | 30 | 713 | 2385 ± 93 |

Because other modifications and changes varied to fit particular operating requirements and environments will be apparent to those skilled in the art, the disclosure is not considered limited to the example chosen for purposes of illustration, and covers all changes and modifications which do not constitute departures from the true spirit and scope of this disclosure.

Accordingly, the foregoing description is given for clearness of understanding only, and no unnecessary limitations should be understood therefrom, as modifications within the scope of the disclosure may be apparent to those having ordinary skill in the art.

All patents, patent applications, government publications, government regulations, and literature references cited in this specification are hereby incorporated herein by reference in their entirety. In case of conflict, the present description, including definitions, will control.

Throughout the specification, where the compositions, processes, kits, or apparatus are described as including components, steps, or materials, it is contemplated that the compositions, processes, or apparatus can also comprise, consist essentially of, or consist of, any combination of the recited components or materials, unless described otherwise. Component concentrations can be expressed in terms of weight concentrations, unless specifically indicated otherwise. Combinations of components are contemplated to include homogeneous and/or heterogeneous mixtures, as would be understood by a person of ordinary skill in the art in view of the foregoing disclosure.

1. A method for forming an oxyalkylated lignin polyol, the method comprising:
providing a reaction mixture comprising:
a cyclic alkyl carbonate,
a lignin,
a polyol reactive co-solvent, and
an oxyalkylation catalyst; and
performing an oxyalkylation reaction in the reaction mixture to react the cyclic alkyl carbonate with the lignin, thereby forming an oxyalkylated lignin polyol reaction product.

2. The method of claim 1, wherein the oxyalkylation reaction further reacts the cyclic alkyl carbonate with the polyol, thereby forming a ring-opened adduct of the polyol and the cyclic alkyl carbonate.

3. The method of claim 1, wherein unreacted cyclic alkyl carbonate remaining in the reaction product is not more than 30 wt. % relative to total cyclic alkyl carbonate added to the reaction mixture.

4. The method of claim 1, wherein:
the cyclic alkyl carbonate is present in the reaction mixture in an amount of 10-50 wt. %;
the lignin is present in the reaction mixture in an amount of 10-50 wt. %; and
the polyol is present in the reaction mixture in an amount of 10-50 wt. %.

5. The method of claim 1, wherein the polyol comprises a poly(alkylene oxide) diol.

6. The method of claim 1, wherein the polyol has a molecular weight in a range of 50-5000 g/mol.

7. The method of claim 2, further comprising:
performing a transesterification reaction with a dialkyl carbonate, thereby reacting (i) the dialkyl carbonate with (ii) one or both of the oxyalkylated lignin polyol and the ring-opened adduct of the polyol and the cyclic alkyl carbonate, thereby forming a plurality of carbonate adducts with the lignin and the polyol, and/or units thereof, and an alcohol corresponding to the dialkyl carbonate.

8. The method of claim 7, wherein the dialkyl carbonate comprises at least one of dimethyl carbonate and diethyl carbonate.

9. The method of claim 7, wherein the dialkyl carbonate is present in an amount in a range of 0.2 eq. to 2 eq. relative to total hydroxy content in the reaction mixture after the oxyalkylation reaction.

10. The method of claim 7, further comprising:
removing at least a portion of the alcohol formed during the transesterification reaction from a reaction vessel for the transesterification reaction.

11. The method of claim 7, comprising performing the transesterification reaction (i) at a temperature in a range of 80-200° C., (ii) for time of 0.1-2 hr, and optionally (iii) at a pressure in a range of 0.5 to 2 bar.

12. A method for forming an oxyalkylated lignin polyol, the method comprising:
providing a reaction mixture comprising:
a cyclic alkyl carbonate,
a lignin, and
an oxyalkylation catalyst;
performing an oxyalkylation reaction in the reaction mixture to react the cyclic alkyl carbonate with the lignin, thereby forming an oxyalkylated lignin polyol reaction product; and
performing a transesterification reaction at reduced pressure, thereby reacting (i) oxyalkylated lignin polyol with (ii) one or both of lignin and oxyalkylated lignin polyol, thereby forming a diol corresponding to the cyclic alkyl carbonate.

13. (canceled)

14. (canceled)

15. (canceled)

16. A method for forming an oxyalkylated lignin polyol, the method comprising:
providing a reaction mixture comprising:
a cyclic alkyl carbonate,
a lignin, and
an oxyalkylation catalyst; and
performing an oxyalkylation reaction in the reaction mixture to react the cyclic alkyl carbonate with the lignin, thereby forming an oxyalkylated lignin polyol reaction product;
wherein the lignin, prior to incorporation into the reaction mixture, has at least one of the following properties:
a molecular weight in a range of 500 to 10000;
a polydispersity in a range of 1.2 to 5;
an aliphatic hydroxyl content in a range of 0.5 to 7 mmol/g;
a phenol hydroxyl content in a range of 1 to 7 mmol/g;
a carboxylic hydroxyl content less than 1 mmol/g; and
a total hydroxyl content in a range of 2 to 10 mmol/g.

17. (canceled)

18. (canceled)

19. A method for forming an oxyalkylated lignin polyol, the method comprising:
providing a reaction mixture comprising:
a dialkyl carbonate,
a polyol reactive co-solvent, and
an oxyalkylation catalyst;
performing a first transesterification reaction, thereby reacting (i) the dialkyl carbonate with (ii) the polyol, thereby forming a carbonate-terminated derivative of the polyol and an alcohol corresponding to the dialkyl carbonate; and
performing a second transesterification reaction with a lignin, thereby reacting (i) the carbonate-terminated derivative of the polyol with (ii) the lignin, thereby forming a polycarbonate oxyalkylated lignin polyol.

20. (canceled)

21. (canceled)

22. (canceled)

23. (canceled)

24. (canceled)

25. (canceled)

26. A method for forming an oxyalkylated lignin polyol, the method comprising:
providing a reaction mixture comprising:
a cyclic alkyl carbonate,
a lignin, and
an oxyalkylation catalyst;
performing an oxyalkylation reaction in the reaction mixture to react the cyclic alkyl carbonate with the lignin, thereby forming an oxyalkylated lignin polyol reaction product with unreacted excess cyclic alkyl carbonate;
performing a ring-opening reaction with water, thereby reacting (i) the water with (ii) the unreacted excess cyclic alkyl carbonate, thereby forming a polycarbonate alkylene polyol.

27. (canceled)

28. (canceled)

29. (canceled)

30. (canceled)

31. (canceled)

32. The method of claim 1, wherein:
the oxyalkylated lignin polyol reaction product is a liquid at ambient temperatures;
the oxyalkylated lignin polyol reaction product has a viscosity at 25° C. and shear rate of 50 s⁻¹ or 1000 s⁻¹ (1000 μm gap) in a range of 5 to 2000000 cP;
the oxyalkylated lignin polyol reaction product has a hydroxy value in a range of 20 to 500 mg KOH/g; and
the oxyalkylated lignin polyol reaction product has an aliphatic hydroxy content in a range of 0.2 mmol/g to 6 mmol/g.

33. (canceled)

34. The method of claim 1, wherein:
the oxyalkylation catalyst is present in the reaction mixture in an amount in a range of 0.04 eq to 0.06 eq relative to the lignin hydroxyl content;
the oxyalkylation catalyst is present in the reaction mixture in an amount in a range of 0.025 eq to 0.05 eq relative to the lignin phenolic hydroxyl content;
the cyclic alkyl carbonate is present in the reaction mixture in an amount in a range of 1 eq to 10 eq relative to the lignin hydroxyl content; and
the oxyalkylation catalyst is selected from the group consisting of 1,8-diazabicyclo[5.4.0]undec-7-ene (DBU), 1,5,7-Triazabicyclo[4.4.0]dec-5-ene, 1,4-diazabicyclo[2.2.2]octane (DABCO), potassium tert-butoxide, tetra-n-butylammonium bromide (TBAB) (phase transfer catalyst), potassium carbonate, pyridine, triethylene amine, and combinations thereof.

35. (canceled)

36. (canceled)

37. (canceled)

38. (canceled)

39. (canceled)

40. The method of claim 1, wherein the cyclic alkyl carbonate has a structure according to Formula I: 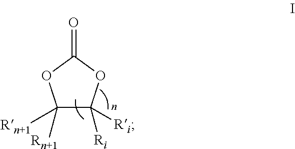
wherein:
n is 1 to 10;
i is each of 1 to n; and
Rᵢ, R′ᵢ, Rₙ₊₁, and R′ₙ₊₁ are independently selected from the group consisting of H and linear or branched, substituted or unsubstituted C₁-C₁₀ alkyl groups.

41. (canceled)

42. (canceled)

43. (canceled)

44. The method of claim 1, wherein the cyclic alkyl carbonate comprises propylene carbonate.

45. The method of claim 1, wherein;
the lignin is derived from a biomass selected from the group consisting of hardwoods, softwoods, grasses, and combinations thereof;
the lignin is isolated from an extraction process selected from the group consisting of Kraft extraction, soda extraction, organosolv extraction, enzymatic hydrolysis extraction, ionic liquid, extraction, sulfite extraction, and combinations thereof; and
the lignin, prior to incorporation into the reaction mixture, has the following properties:
a number-average molecular weight (Mn) in a range of 500 to 5000;
a polydispersity in a range of 1.2 to 8;
a phenol hydroxyl content in a range of 1 to 7 mmol/g;
a relative phenol hydroxyl content of at least 45% relative to hydroxyl groups of the unmodified lignin; and
a carboxylic hydroxyl content less than 1 mmol/g.

46. (canceled)

47. (canceled)

48. (canceled)

49. (canceled)

50. (canceled)

51. (canceled)

52. (canceled)

53. (canceled)

54. The method of claim 1, further comprising:
adding an oil to the oxyalkylated lignin polyol reaction product, thereby (i) extracting at least a portion of unreacted cyclic alkyl carbonate from the reaction product into a separate oil phase comprising the oil and (ii) forming a concentrated oxyalkylated lignin polyol containing a reduced amount of cyclic alkyl carbonate relative to the oxyalkylated lignin polyol reaction product.

55. The method of claim 1, further comprising:
adding an isocyanate to the oxyalkylated lignin polyol reaction product and reacting the isocyanate and the oxyalkylated lignin polyol reaction product to form a polyurethane polymer or prepolymer.

56. The method of claim 1, further comprising:
adding an organic acid to the oxyalkylated lignin polyol reaction product and reacting the organic acid and the oxyalkylated lignin polyol reaction product to form a polyester polymer.

57. An oxyalkylated lignin polyol reaction product formed according to the method of claim 1.

58. (canceled)

59. A polyurethane polymer formed according to the method of claim 55.

60. (canceled)

61. A polyester polymer formed according to the method of claim 56.
